(19) United States
(12) Patent Application Publication
(10) Pub. No.: US 2021/0097449 A1
(43) Pub. Date: Apr. 1, 2021

(54) MEMORY-EFFICIENT SYSTEM FOR DECISION TREE MACHINE LEARNING

(71) Applicant: Intel Corporation, Santa Clara, CA (US)

(72) Inventors: Rita Chattopadhyay, Chandler, AZ (US); Rajesh Bansal, Sengkang (SG)

(73) Assignee: Intel Corporation, Santa Clara, CA (US)

(21) Appl. No.: 17/120,059

(22) Filed: Dec. 11, 2020

(51) Int. Cl. G06N 20/20; G06N 5/00; G06N 5/04

(52) U.S. Cl. CPC G06N 20/20; G06N 5/04; G06N 5/003

(57) ABSTRACT

In one embodiment, a processing device for training a decision tree model includes memory and processing circuitry. The processing circuitry allocates a tree node array in memory, where the number of array elements in the tree node array equals the number of data samples in a training dataset. The processing circuitry also obtains the training dataset, which contains data samples captured at least partially by sensor(s). The processing circuitry then trains the decision tree model. For example, a root node is initially assigned to the data samples in the training dataset. The root node is recursively split into child nodes based on identified branch conditions, where each child node is assigned to a subset of data samples. The tree node array is continuously updated during training to identify the child nodes assigned to the data samples. The processing circuitry then stores the trained decision tree model in memory.

### FIELD OF THE SPECIFICATION

This disclosure relates in general to the field of artificial intelligence and machine learning, and more particularly, though not exclusively, to a memory-efficient system for decision tree machine learning.

### BACKGROUND

Tree data structures, such as binary trees and decision trees, have a wide variety of applications in computer science, from data storage and searching to artificial intelligence and machine learning. These data structures can be quite memory inefficient, however, particularly when stored on fixed-memory architectures that require memory to be statically allocated before runtime. For example, since the actual size of each tree node is not known until runtime, the amount of pre-allocated memory must be large enough to accommodate the maximum possible size for each tree node, even though most or all nodes will not use that much memory.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a schematic diagram of an example computing system in accordance with certain embodiments.

FIG. 2 illustrates an example of data discretization.

FIG. 3 illustrates a block diagram for an example embodiment of optimized data discretization.

FIG. 4 illustrates a flowchart for an example embodiment of optimized data discretization.

FIGS. 5A-E provide a comparison of various data discretization approaches in a variety of use cases.

FIG. 6 illustrates an example embodiment of an electronic device with data discretization functionality.

FIG. 7 illustrates an example embodiment of an edge device with an optimized decision tree machine learning (ML) engine.

FIGS. 8A-B illustrate an overview of a random forest machine learning (ML) algorithm.

FIGS. 9A-C illustrate an example of using automated data binning to compute feature value checkpoints for training a decision tree model.

FIG. 10 illustrates a process flow for efficiently training a random forest machine learning (ML) model in accordance with certain embodiments.

FIG. 11 illustrates an example embodiment of an artificial intelligence (AI) accelerator implemented with an optimized decision tree machine learning (ML) engine.

FIGS. 12A-G illustrate a performance comparison of an optimized random forest versus a traditional random forest.

FIG. 13 illustrates a flowchart for performing decision tree training and inference in accordance with certain embodiments.

FIG. 14 illustrates the structure of a decision tree in a typical random forest machine learning classifier.

FIG. 15 illustrates an example implementation of a tree data structure on a fixed-memory hardware architecture.

FIG. 16 illustrates a memory-efficient implementation of a tree data structure.

FIGS. 17A-B illustrate a memory usage comparison for various implementations of tree data structures.

FIG. 18 illustrates a flowchart for a memory-efficient implementation of decision tree machine learning in accordance with certain embodiments.

FIG. 19 illustrates an overview of an edge cloud configuration for edge computing.

FIG. 20 illustrates operational layers among endpoints, an edge cloud, and cloud computing environments.

FIG. 21 illustrates an example approach for networking and services in an edge computing system.

FIG. 22 illustrates a compute and communication use case involving mobile access to applications in an edge computing system.

FIG. 23A provides an overview of example components for compute deployed at a compute node in an edge computing system.

FIG. 23B provides a further overview of example components within a computing device in an edge computing system.

FIG. 24 illustrates an example software distribution platform to distribute software to one or more devices in accordance with certain embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Optimized Data Discretization and Binning

Data analytics has a wide range of applications in computing systems, from data mining to machine learning and artificial intelligence, and has become an increasingly important aspect of large-scale computing applications. Data preprocessing, an important initial step in data analytics, involves transforming raw data into a suitable format for further processing and analysis. For example, real-world or raw data is often incomplete, inconsistent, and/or error prone. Accordingly, raw data may go through a series of preprocessing steps, such as data cleaning, integration, transformation, reduction, and/or discretization or quantization. Data discretization, for example, may involve converting or partitioning a range of continuous raw data into a smaller number of intervals or values. For example, data binning is a form of data discretization that involves grouping a collection of continuous values into a smaller number of “bins” that each represent a particular interval or range. The original data values may each be grouped into a defined interval or bin, and thus may be replaced by a value representative of that interval or bin, such as a center or boundary value of the interval. As an example, a collection of data identifying the age of a group of people may be binned into a smaller number of age intervals. In this manner, the raw data values are aggregated and the size of the dataset is reduced, and the resulting binned dataset may then be used for further analysis and processing, such as for data mining or machine learning and artificial intelligence (e.g., computer vision, autonomous navigation, computer or processor optimizations, speech and audio recognition, natural language processing). A histogram is an example of data binning that may be used for analyzing the underlying data distribution of the raw data. A histogram, for example, may be a representation of a data distribution that provides an estimate of the probability distribution of a continuous variable. A histogram may be represented in various forms, such as a data structure and/or a graphical representation. Moreover, a histogram may be constructed, for example, by “binning” a range of values into a series of smaller intervals, and then counting the number of values in each bin or interval. Histograms are powerful tools for categorizing or discretizing real-world data for further processing and analysis.

A significant challenge of data discretizing and binning is selecting the optimal bin size, such as a bin size that is sufficiently large but also preserves the original data distribution. For example, a binned dataset or histogram should provide meaningful binning of data into fewer categories for efficient data correlation and association (e.g., as required for many data mining and/or machine learning techniques), while also accurately representing the original data distribution. For advanced data processing techniques (e.g., clustering and pattern matching for data mining and/or machine learning purposes), it may be ideal for raw data to be binned into fewer bins with a larger bin size, as that may result in the raw data being summarized into meaningful segments, which may be particularly beneficial for datasets that span a large range of data and/or contain a large volume of data samples. On the other hand, however, decreasing the number of bins, and thus increasing the bin size, may cause the histogram or binned dataset to deviate from the inherent data distribution of the original raw dataset. Thus, the bin size should not be so small that the histogram loses its purpose, but should not be so large that the histogram significantly deviates from the original data distribution. Accordingly, determining the optimal bin size or bin width for performing data discretization and binning may be challenging.

Many approaches to selecting a bin size for data discretization and binning suffer from various drawbacks. For example, the bin size could be determined arbitrarily, but an arbitrary bin size may fail to provide a meaningful summarization of data and/or may fail to preserve the original data distribution, thus reducing overall performance. As another example, the bin size could be determined manually, but a manual approach can be a tedious and daunting task and may be prone to error. As another example, the bin size could be determined using certain formulas, such as the Freedman-Diaconis formula. However, those formulas often result in bin sizes that are too small to provide a meaningful summarization of data, and thus are not very useful for practical purposes, particularly when the dataset covers a large range of data and when developing a meaningful histogram is crucial to the success of the subsequent data processing methods (e.g., data mining and machine learning).

Accordingly, this disclosure describes various embodiments for selecting an optimal bin size for data discretization and binning. The described embodiments can be used to identify a bin size that provides a meaningful categorization or summarization of raw data without significantly deviating from the original data distribution. For example, the optimal bin size may be large enough to provide a meaningful summarization of the raw data, but small enough to preserve the original data distribution. In this manner, the described embodiments provide an optimal balance between these competing factors. Moreover, the described embodiments can be used to automatically discretize or bin data in a manner that is optimal for subsequent processing and analysis. Accordingly, the described embodiments can be used to improve the performance of large-scale applications or solutions (e.g., Internet-of-Things (IoT) applications) that depend on advanced data processing techniques, such as data mining, cognitive learning, machine learning, associative memory techniques, and artificial intelligence (e.g., using artificial neural networks), among other examples. Moreover, by automating the data discretization and binning process, the described embodiments reduce the analytics development time and the time-to-market for analytics applications. Finally, because the described embodiments are also computationally efficient, they are optimal even for resource-constrained devices (e.g., edge devices).

The described embodiments are particularly beneficial for use cases where developing a meaningful histogram is crucial to the success of the subsequent data processing methods, such as data mining or machine learning and artificial intelligence (e.g., computer vision, autonomous navigation, computer or processor optimizations, associative memory, speech and audio recognition, natural language processing). As an example, the described embodiments can be utilized with associative memory techniques that track co-occurrences of data values or data elements in order to identify associations and relationships between them.

Example embodiments that may be used to implement the features and functionality of this disclosure will now be described with more particular reference to the attached FIGURES.

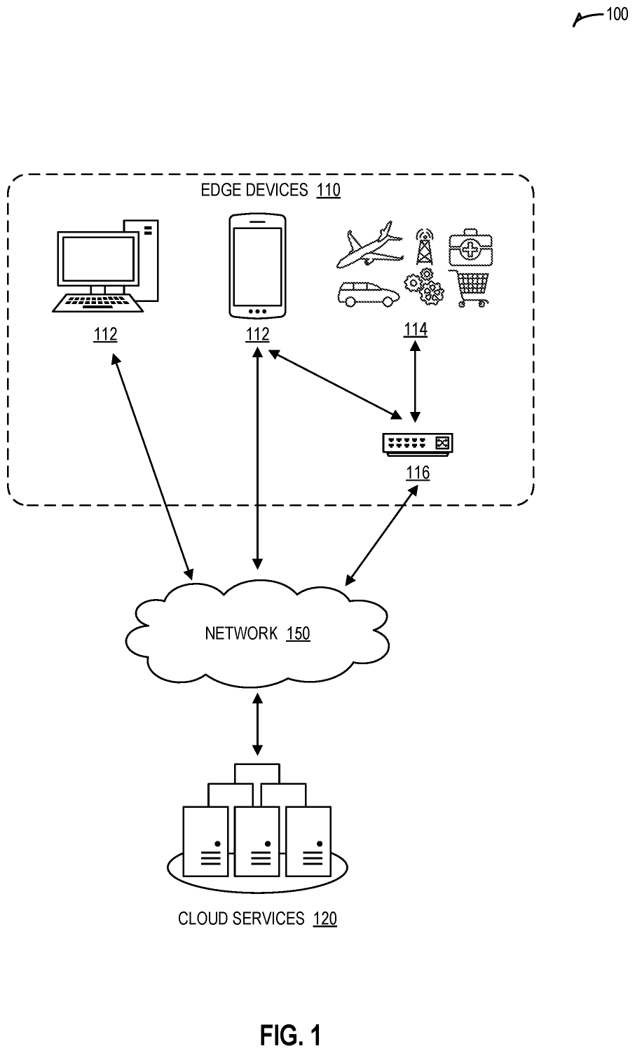

FIG. 1 illustrates a schematic diagram of an example computing system 100. In various embodiments, system 100 and/or its underlying components may include functionality described throughout this disclosure for performing data discretization and binning using an optimal bin size. For example, data discretization functionality may be used in system 100 for a wide range of applications and/or use cases, from data mining to machine learning and artificial intelligence, among other examples. Moreover, data discretization functionality may be implemented by any component of system 100, such as edge devices 110, cloud services 120, and communications network 150. These various components of system 100, for example, could be implemented with data discretization functionality using optimal bin sizes, as described further throughout this disclosure in connection with the remaining FIGURES.

The various components in the illustrated example of computing system 100 will now be discussed further below.

Edge devices 110 may include any equipment and/or devices deployed or connected near the “edge” of a communication system 100. In the illustrated embodiment, edge devices 110 include end-user devices 112 (e.g., desktops, laptops, mobile devices), Internet-of-Things (IoT) devices 114, and gateways and/or routers 116, among other examples. Edge devices 110 may communicate with each other and/or with other remote networks and services (e.g., cloud services 120) through one or more networks and/or communication protocols, such as communication network 150. Moreover, in some embodiments, certain edge devices 110 may include the data discretization functionality described throughout this disclosure.

End-user devices 112 may include any device that enables or facilitates user interaction with computing system 100, including, for example, desktop computers, laptops, tablets, mobile phones and other mobile devices, and wearable devices (e.g., smart watches, smart glasses, headsets), among other examples.

IoT devices 114 may include any device capable of communicating and/or participating in an Internet-of-Things (IoT) system or network. IoT systems may refer to new or improved ad-hoc systems and networks composed of multiple different devices (e.g., IoT devices 114) interoperating and synergizing for a particular application or use case. Such ad-hoc systems are emerging as more and more products and equipment evolve to become “smart,” meaning they are controlled or monitored by computer processors and are capable of communicating with other devices. For example, an IoT device 114 may include a computer processor and/or communication interface to allow interoperation with other components of system 100, such as with cloud services 120 and/or other edge devices 110. IoT devices 114 may be “greenfield” devices that are developed with IoT capabilities from the ground-up, or “brownfield” devices that are created by integrating IoT capabilities into existing legacy devices that were initially developed without IoT capabilities. For example, in some cases, IoT devices 114 may be built from sensors and communication modules integrated in or attached to “things,” such as equipment, toys, tools, vehicles, living things (e.g., plants, animals, humans), and so forth. Alternatively, or additionally, certain IoT devices 114 may rely on intermediary components, such as edge gateways or routers 116, to communicate with the various components of system 100.

IoT devices 114 may include various types of sensors for monitoring, detecting, measuring, and generating sensor data and signals associated with characteristics of their environment. For instance, a given sensor may be configured to detect one or more respective characteristics, such as movement, weight, physical contact, biometric properties, temperature, wind, noise, light, position, humidity, radiation, liquid, specific chemical compounds, battery life, wireless signals, computer communications, and bandwidth, among other examples. Sensors can include physical sensors (e.g., physical monitoring components) and virtual sensors (e.g., software-based monitoring components). IoT devices 114 may also include actuators to perform various actions in their respective environments. For example, an actuator may be used to selectively activate certain functionality, such as toggling the power or operation of a security system (e.g., alarm, camera, locks) or household appliance (e.g., audio system, lighting, HVAC appliances, garage doors), among other examples.

Indeed, this disclosure contemplates use of a potentially limitless universe of IoT devices 114 and associated sensors/actuators. IoT devices 114 may include, for example, any type of equipment and/or devices associated with any type of system 100 and/or industry, including transportation (e.g., automobile, airlines), industrial manufacturing, energy (e.g., power plants), telecommunications (e.g., Internet, cellular, and television service providers), medical (e.g., healthcare, pharmaceutical), food processing, and/or retail industries, among others. In the transportation industry, for example, IoT devices 114 may include equipment and devices associated with aircrafts, automobiles, or vessels, such as navigation systems, autonomous flight or driving systems, traffic sensors and controllers, and/or any internal mechanical or electrical components that are monitored by sensors (e.g., engines). IoT devices 114 may also include equipment, devices, and/or infrastructure associated with industrial manufacturing and production, shipping (e.g., cargo tracking), communications networks (e.g., gateways, routers, servers, cellular towers), server farms, electrical power plants, wind farms, oil and gas pipelines, water treatment and distribution, wastewater collection and treatment, and weather monitoring (e.g., temperature, wind, and humidity sensors), among other examples. IoT devices 114 may also include, for example, any type of “smart” device or system, such as smart entertainment systems (e.g., televisions, audio systems, videogame systems), smart household or office appliances (e.g., heat-ventilation-air-conditioning (HVAC) appliances, refrigerators, washers and dryers, coffee brewers), power control systems (e.g., automatic electricity, light, and HVAC controls), security systems (e.g., alarms, locks, cameras, motion detectors, fingerprint scanners, facial recognition systems), and other home automation systems, among other examples. IoT devices 114 can be statically located, such as mounted on a building, wall, floor, ground, lamppost, sign, water tower, or any other fixed or static structure. IoT devices 114 can also be mobile, such as devices in vehicles or aircrafts, drones, packages (e.g., for tracking cargo), mobile devices, and wearable devices, among other examples. Moreover, an IoT device 114 can also be any type of edge device 110, including end-user devices 112 and edge gateways and routers 116.

Edge gateways and/or routers 116 may be used to facilitate communication to and from edge devices 110. For example, gateways 116 may provide communication capabilities to existing legacy devices that were initially developed without any such capabilities (e.g., “brownfield” IoT devices). Gateways 116 can also be utilized to extend the geographical reach of edge devices 110 with short-range, proprietary, or otherwise limited communication capabilities, such as IoT devices 114 with Bluetooth or ZigBee communication capabilities. For example, gateways 116 can serve as intermediaries between IoT devices 114 and remote networks or services, by providing a front-haul to the IoT devices 114 using their native communication capabilities (e.g., Bluetooth, ZigBee), and providing a back-haul to other networks 150 and/or cloud services 120 using another wired or wireless communication medium (e.g., Ethernet, Wi-Fi, cellular). In some embodiments, a gateway 116 may be implemented by a dedicated gateway device, or by a general purpose device, such as another IoT device 114, end-user device 112, or other type of edge device 110.

In some instances, gateways 116 may also implement certain network management and/or application functionality (e.g., IoT management and/or IoT application functionality for IoT devices 114), either separately or in conjunction with other components, such as cloud services 120 and/or other edge devices 110. For example, in some embodiments, configuration parameters and/or application logic may be pushed or pulled to or from a gateway device 116, allowing IoT devices 114 (or other edge devices 110) within range or proximity of the gateway 116 to be configured for a particular IoT application or use case.

Cloud services 120 may include services that are hosted remotely over a network 150, or in the “cloud.” In some embodiments, for example, cloud services 120 may be remotely hosted on servers in datacenter (e.g., application servers or database servers). Cloud services 120 may include any services that can be utilized by or for edge devices 110, including but not limited to, data storage, computational services (e.g., data analytics, searching, diagnostics and fault management), security services (e.g., surveillance, alarms, user authentication), mapping and navigation, geolocation services, network or infrastructure management, IoT application and management services, payment processing, audio and video streaming, messaging, social networking, news, and weather, among other examples. Moreover, in some embodiments, certain cloud services 120 may include the data discretization functionality described throughout this disclosure.

Network 150 may be used to facilitate communication between the components of computing system 100. For example, edge devices 110, such as end-user devices 112 and IoT devices 114, may use network 150 to communicate with each other and/or access one or more remote cloud services 120. Network 150 may include any number or type of communication networks, including, for example, local area networks, wide area networks, public networks, the Internet, cellular networks, Wi-Fi networks, short-range networks (e.g., Bluetooth or ZigBee), and/or any other wired or wireless networks or communication mediums.

Any, all, or some of the computing devices of system 100 may be adapted to execute any operating system, including Linux or other UNIX-based operating systems, Microsoft Windows, Windows Server, MacOS, Apple iOS, Google Android, or any customized and/or proprietary operating system, along with virtual machines adapted to virtualize execution of a particular operating system.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

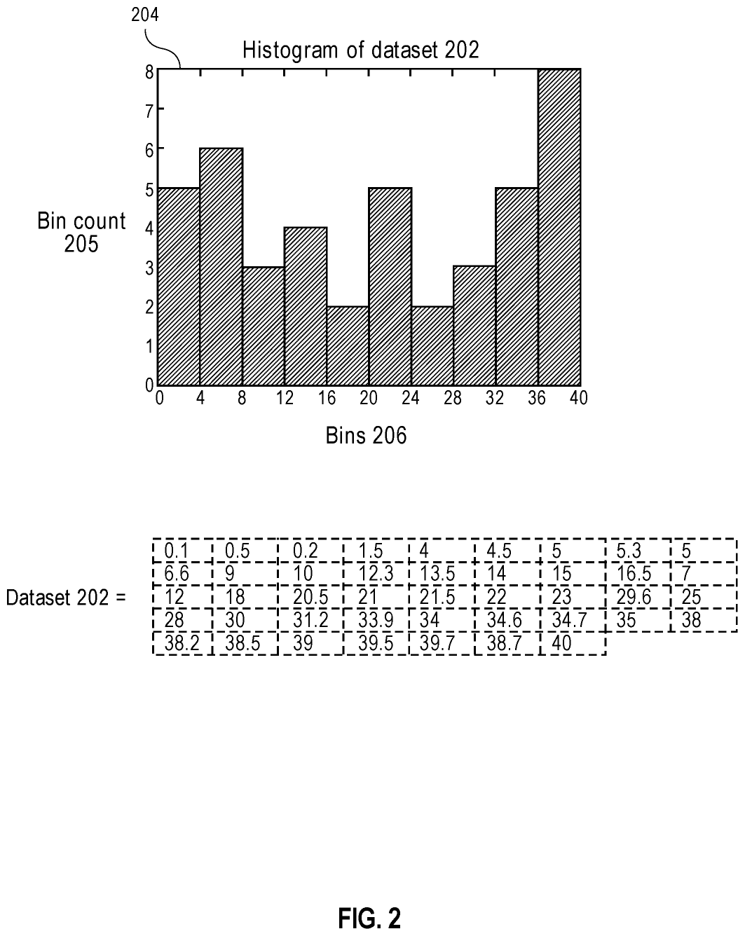

FIG. 2 illustrates an example 200 of data discretization. In the illustrated example, a histogram 204 is created for a dataset 202 by performing data discretization using an arbitrary bin size of 4. Dataset 202 is an array of example numerical data, which contains 43 total data elements with values ranging between 0 and 40. Using an arbitrary bin size or bin width of 4, the entire range of values of dataset 202 (from 0 to 40) is broken down into intervals of 4, and each interval is represented by a separate bin, resulting in a total of 10 bins. The data elements of dataset 202 are then grouped into the appropriate bin, and the number of data elements in each bin are counted. A histogram 204 is then used to represent the number of data elements in each bin. In the illustrated example, the y-axis of histogram 204 represents the bin count 205 (e.g., the number of data elements in a bin), and the x-axis represents the various bins 206. For example, bin 12 has a bin count of 3, which means there are 3 data elements in dataset 202 that are greater than 8 and less than or equal to 12 (e.g., data values 9, 10, and 12 in dataset 204).

The resulting histogram 204 represents an approximation of the data distribution of dataset 202. The granularity or precision of the approximated data distribution of a histogram is based on the bin size. While smaller bin sizes may result in a more precise representation of the original data distribution, larger bin sizes may result in fewer bins or categories which may be more efficient for subsequent analysis and processing. Thus, although an arbitrary bin size of 4 was used in the illustrated example, the optimal bin size for a given dataset may vary. Accordingly, it may be beneficial to determine an optimal bin size for a given dataset to ensure that the discretized data provides a useful summary of the dataset without significantly deviating from the original data distribution. In some embodiments, for example, an optimal bin size can be determined using the cost function described throughout this disclosure in connection with the remaining FIGURES.

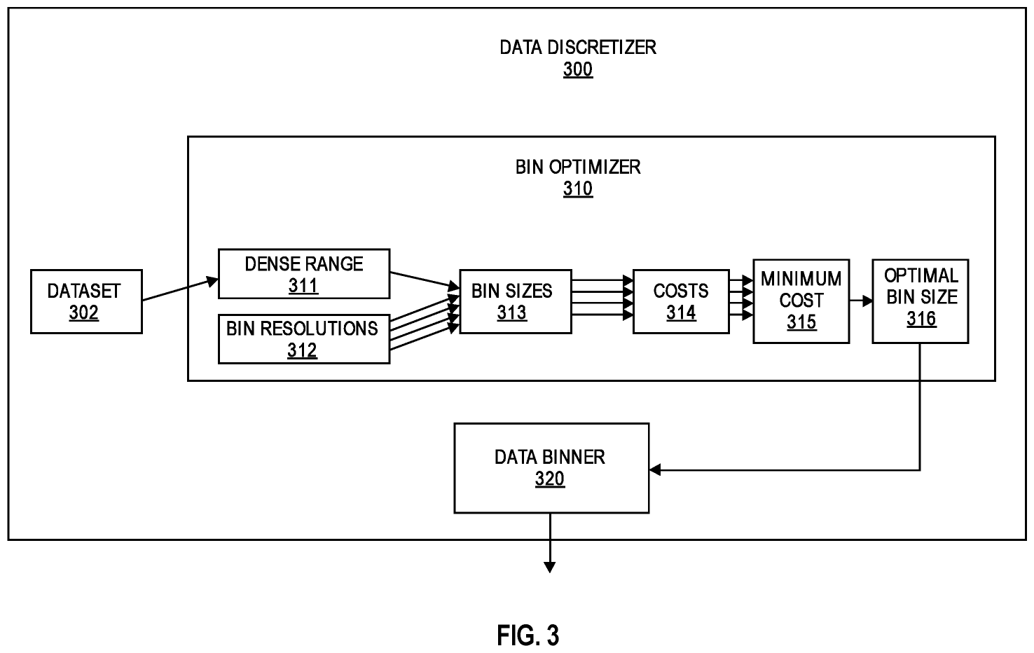

FIG. 3 illustrates a block diagram for an example embodiment of optimized data discretization. The illustrated embodiment includes a data discretizer 300 for automatically performing data discretization on a particular dataset using an optimal bin size. For example, data discretizer 300 may determine an optimal bin size that ensures the discretized data provides a meaningful summary of the dataset without significantly deviating from the original data distribution. For example, the optimal bin size may be large enough to provide a meaningful summarization of the dataset, but small enough to preserve the original data distribution. In various embodiments, functionality of data discretizer 300 may be implemented using any type or combination of hardware and/or software logic, such as a processor (e.g., a microprocessor), application specific integrated circuit (ASIC), field programmable gate array (FPGA), or another type of integrated circuit or computing device or data processing device, and/or any associated software logic, instructions, or code.

In the illustrated embodiment, data discretizer 300 determines the optimal bin size using a cost function to minimize the difference in data distribution (before and after discretization) while maximizing the bin size. The cost function C can be represented using the following equation:

$$cost C = \frac{max ( differences between adjacent bin counts )}{bin size} \qquad ( 1 )$$

In the above cost function C from equation (1), “bin counts” refers to the number of data elements that fall into each discretized bin for a particular bin size, and the “differences between adjacent bin counts” refers to the difference in bin count between each pair of adjacent bins. In some embodiments, for example, the differences between adjacent bin counts may be determined by subtracting the n^{th} bin count from the (n−1)^{th} bin count. Accordingly, the cost C for a particular bin size may be calculated by identifying the maximum value of the differences between adjacent bin counts, and dividing that by the particular bin size. The optimal bin size for a particular dataset is the bin size with the smallest cost value C. Accordingly, the optimal bin size can be determined by solving for the particular bin size that minimizes the value of cost function C, for example, over a particular range of bin sizes.

Minimizing the cost function C in this manner effectively minimizes the maximum difference between adjacent bin counts (since that value is in the numerator), while simultaneously favoring larger bin sizes (since the bin size is in the denominator). This ensures that the resulting histogram provides the optimal balance between preserving the original data distribution while maximizing the bin size.

In the illustrated embodiment, data discretizer 300 includes a bin optimizer 310 that can be used to identify the optimal bin size for binning dataset 302. Bin optimizer 310 first identifies a dense range 311 of the dataset 302. In some embodiments, for example, the mean and standard deviation of the dataset 302 may be computed, and then dense range 311 may be identified as a range that is within a particular number of standard deviations from the mean. For example, in some embodiments (e.g., for datasets with Gaussian distributions), the dense range 311 may be +−2 standard deviations from the mean. Accordingly, identifying the dense data range in this manner ensures that outliers or data with long tails do not impact the optimal bin size.

Next, bin optimizer 310 identifies a range of potential bin resolutions 312 for the optimal bin size. In some embodiments, for example, the range of bin resolutions 312 may be identified based on configurable parameters, such as a start resolution, stop resolution, and step. For example, if the start resolution, stop resolution, and step are respectively set using default values of 0.1, 0.2, and 0.001, the resulting bin sizes will range from 10% to 20% of the size of the dense range 311, and in increments of 0.1%. In this manner, the range of potential bin resolutions 312 are used to calculate a range of corresponding bin sizes 313, for example, by multiplying each bin resolution 312 by the size of the dense range 311.

A cost value 314 may then be computed for each bin size 313. For example, for a particular bin size, first the boundaries or center values of the bins may be computed. The bin boundaries for a particular bin size 313 may be computed, for example, by enumerating the dense data range 311 from lowest end to highest end using a step or interval equal to the particular bin size 313. A histogram can then be created for the particular bin size 313, for example, by counting the number of data elements of dataset 302 that fall into each bin. The histogram can then be used to compute the differences in bin count for adjacent bins. For example, for each bin other than the 1^{st} bin, the bin count of the particular bin may be subtracted from the bin count of the preceding bin, and the absolute value of the result may be returned as the difference between those respective bin counts. The maximum value of these differences in adjacent bin count can then be identified. The cost value 314 for the particular bin size 313 can then be computed, for example, using the cost function C identified above (e.g., by dividing the maximum difference in adjacent bin counts by the particular bin size). This process can be repeated in order to compute cost values 314 for all potential bin sizes 313.

The cost values 314 of the respective bin sizes 313 are then used to identify the minimum cost value 315, and the optimal bin size 316 is then identified as the bin size associated with the minimum cost value 315.

The optimal bin size 316 can then used by data binner 320, for example, to perform binning on dataset 302 and/or generate a histogram. For example, the optimal bin size can be used to determine the total number of bins and the interval or range of each bin, and dataset 302 can then be partitioned into the respective bins. The total number of bins, for example, can be computed by dividing the size of the dense data range 311 by the optimal bin size 316 and rounding up the result.

Example pseudocode for implementing the functionality of data discretizer 300 is provided below:

```
// Step 1: Identify dense range of dataset
  mean = mean(dataset); // Compute mean of dataset
  std_dev = std_dev(dataset); // Compute standard deviation of dataset
  dense_range = mean +− 2*std_dev;
  // Compute dense range as +−2 standard deviations
  from the mean
// Step 2: Identify range of potential bin resolutions
  // Initialize the bin size resolutions array
  based on the configuration parameter values
  for start_resolution, step, and end_resolution.
  Default values of start_resolution, step,
  and end_resolution are 0.1, 0.001, and 0.2,
  respectively. These default values produce
  bin sizes ranging from 10% to 20% of
  the dense range, with increments of 0.1%.
  bin_resolution = start_resolution: step : end_resolution;
// Step 3: Calculate cost function (C) for each potential bin size
  for each element [i] in the bin_resolution array:
    // Create a binsize iterator to store the bin
    size computed using the resolution
    from the current iteration of the bin_resolution array
    binsize_iterator = size of dense_range * bin_resolution[i];
    // Save the computed bin size from the
    current iteration in an array
    computed_binsizes[i] = binsize_iterator;
    // Create an array of the bin boundary or center values
    bin_boundaries =
    min(dense_range) : binsize iterator: max(dense_range);
    // Create a histogram based on the bin boundaries
    [counts, bins] = hist(dataset, bin_boundaries);
    // Compute the absolute values of the
    differences between adjacent bin counts,
    and save them in the diffs_adj_bincount array
    diffs_adj_bincount =
    abs(differences between adjacent bin counts);
    // Find the maximum difference
    between adjacent bin counts, and save in the
    max_diff_adj_bincount array
    max_diff_adj_bincount[i] = max(diffs_adj_bincount);
    // Compute the Cost function for this bin size:
    cost[i] = max_diff_adj_bincount[i] / computed_binsizes[i];
// Step 4: Find the optimal bin size with the minimum cost
  [value, index] = min(cost);
  optimal_binsize = computed_binsizes[index];
  // optimal_binsize is the optimal
  discretization bin size for the data
// Step 5: Compute the total number of bins
  optimal_number_of_bins = ceiling(dense_range / optimal_binsize);
```

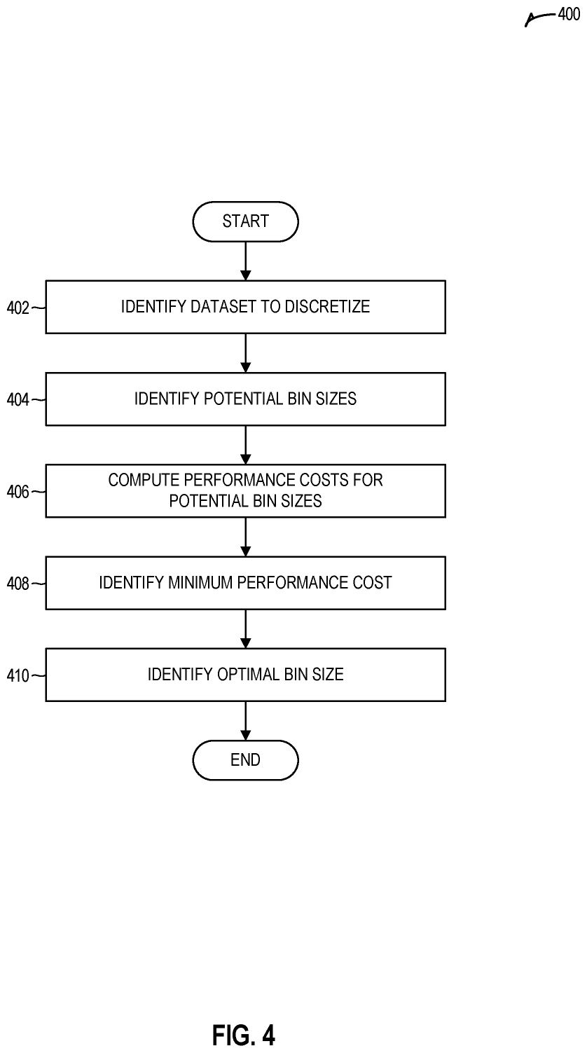

FIG. 4 illustrates a flowchart 400 for an example embodiment of optimized data discretization. Flowchart 400 may be implemented, in some embodiments, using the embodiments and functionality described throughout this disclosure.

The flowchart may begin at block 402 by identifying a dataset for performing data discretization or data binning. The dataset, for example, may be identified based on a plurality of data values or data elements associated with, or provided by, a computing device. In some embodiments, for example, the data values may be provided, generated, and/or obtained by a sensor device (e.g., a sensor associated with an IoT device 114 of FIG. 1), or another type of data processing device.

Moreover, in some embodiments, the dataset may be identified based on a dense data range of a parent dataset. In some embodiments, for example, the mean and standard deviation of a parent dataset may be computed, and the dense data range may be identified as a range that is within a particular number of standard deviations from the mean. For example, in some embodiments (e.g., for datasets with Gaussian distributions), the dense range may be +−2 standard deviations from the mean.

The flowchart may then proceed to block 404 to identify potential bin sizes for binning the dataset. In some embodiments, for example, the potential bin sizes may be based on a range of bin resolutions that are each associated with a percentage of the size of the dataset range. In some embodiments, for example, the range of bin resolutions may be identified based on configurable parameters, such as a start resolution, stop resolution, and step. For example, if the start resolution, stop resolution, and step are respectively set using default values of 0.1, 0.2, and 0.001, the resulting bin sizes will range from 10% to 20% of the size of the data range, and in increments of 0.1%. In this manner, the range of potential bin resolutions are used to calculate a range of corresponding bin sizes, for example, by multiplying each bin resolution by the size of the data range.

The flowchart may then proceed to block 406 to compute a performance cost for each potential bin size. For example, for a particular bin size, first the boundaries or center values of the bins may be computed. The bin boundaries for a particular bin size may be computed, for example, by enumerating the data range of the dataset from lowest end to highest end using a step or interval equal to the particular bin size. A histogram can then be created for the particular bin size, for example, by counting the number of data elements of dataset that fall into each bin. The histogram can then be used to compute the differences in bin count for adjacent bins. For example, for each bin other than the 1^{st} bin, the bin count of the particular bin may be subtracted from the bin count of the preceding bin, and the absolute value of the result may be returned as the difference between those respective adjacent bin counts. The maximum value of these differences in adjacent bin counts can then be identified. The performance cost for the particular bin size can then be computed, for example, by dividing the maximum difference in adjacent bin counts by the particular bin size. This process can be repeated in order to compute performance costs for all potential bin sizes.

The flowchart may then proceed to block 408 to identify the minimum performance cost of the various performance costs for the potential bin sizes.

The flowchart may then proceed to block 410 to identify the optimal bin size. The optimal bin size may be identified, for example, as the bin size associated with the minimum performance cost. Accordingly, the optimal bin size is selected in a manner that maximizes the bin size while minimizing the difference in data distribution.

Moreover, in some embodiments, the optimal bin size may then be used to identify a binned dataset or histogram, for example, by partitioning or binning the original dataset based on the optimal bin size. The binned dataset or histogram may then be used for further processing and analysis, such as for machine learning, neural network, and/or data mining operations.

At this point, the flowchart may be complete. In some embodiments, however, the flowchart may restart and/or certain blocks may be repeated. For example, in some embodiments, the flowchart may restart at block 402 to continue performing data discretization on additional datasets.

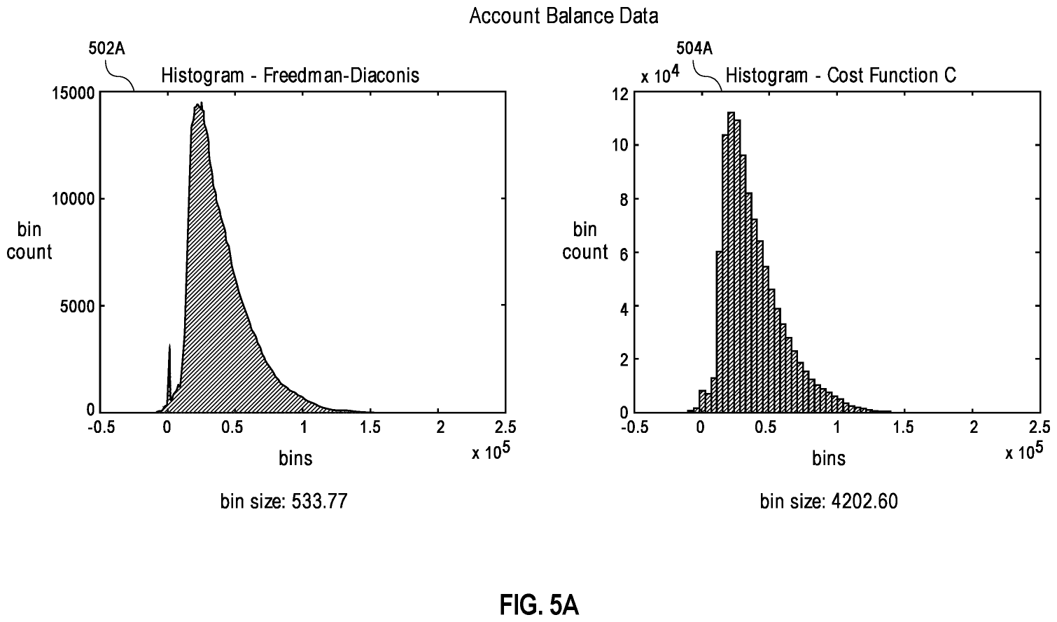

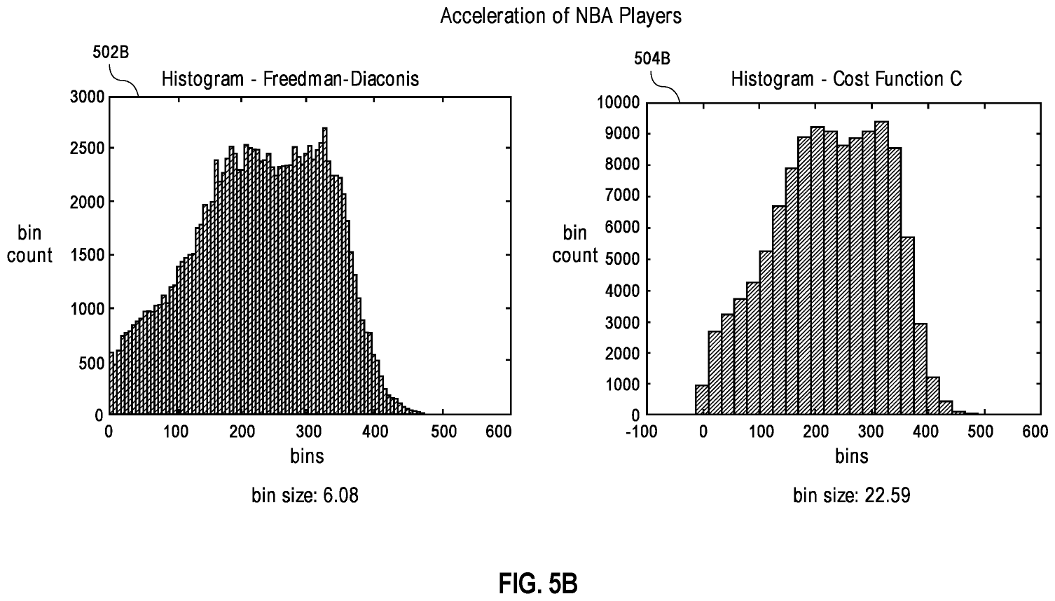

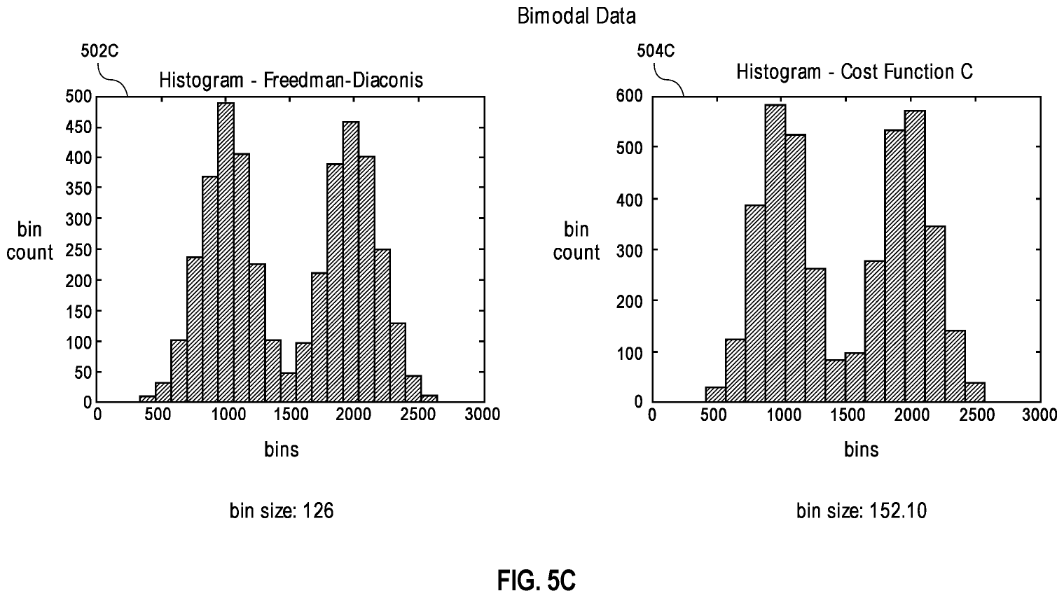

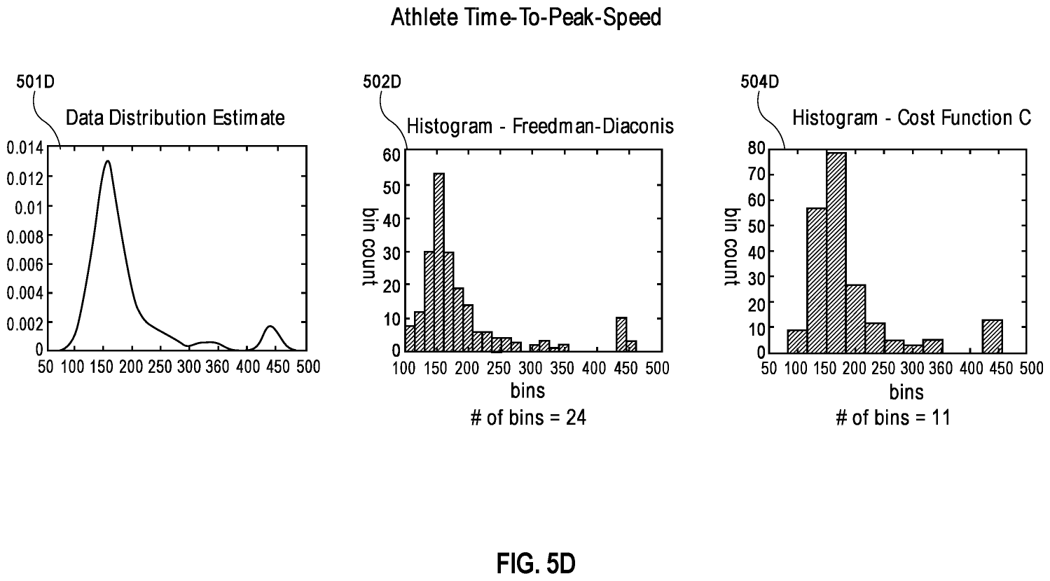

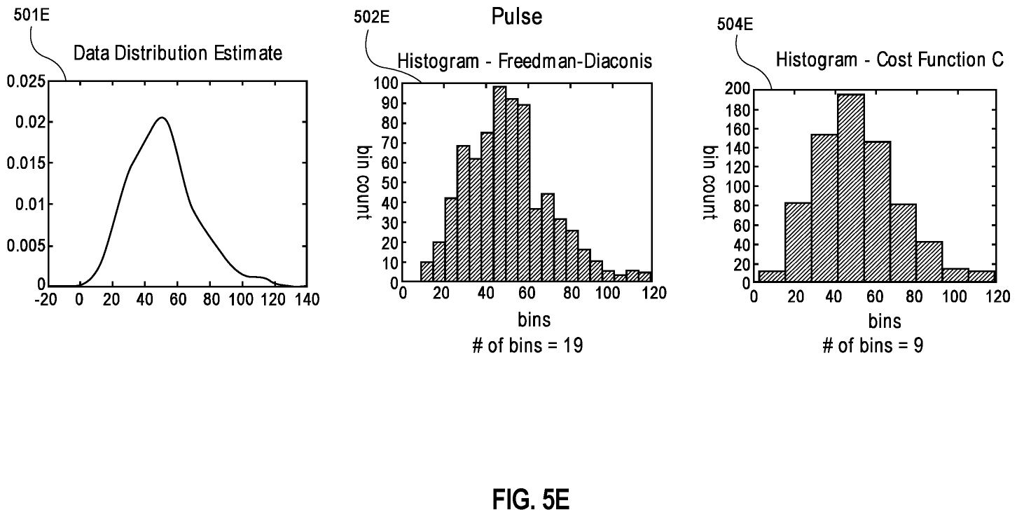

FIGS. 5A-E provide a comparison of various data discretization approaches in a variety of use cases. In particular, FIGS. 5A-E each represent a particular use case, and each use case compares histograms created by discretizing a particular dataset using the Freedman-Diaconis approach versus the cost function approach described throughout this disclosure. The use cases of FIGS. 5A-E respectively illustrate bank account balances (FIG. 5A), acceleration of NBA players (FIG. 5B), bimodal data (FIG. 5C), athlete time-to-peak-speed (FIG. 5D), and pulse (FIG. 5E).

In each example, the histogram created using the Freedman-Diaconis approach is identified by reference numeral 502 (e.g., 502A-E), and the histogram created using the cost function approach is identified by reference numeral 504 (e.g., 504A-E). Moreover, FIGS. 5A-C identify the bin size for each histogram, and FIGS. 5D-E identify the total number of bins for each histogram. FIGS. 5D-E also illustrate a data distribution estimate 501 (e.g., 501D-E) for comparison with the associated histograms.

As shown by these use cases, the bin sizes of the histograms are significantly larger- and similarly the total number of bins is significantly smaller-when using the cost function approach compared to the Freedman-Diaconis approach. In addition, the data distribution is still preserved when using the cost function approach. Accordingly, these use cases demonstrate that the cost function approach described throughout this disclosure provides the optimal balance between maximizing the bin size while minimizing the difference in data distribution.

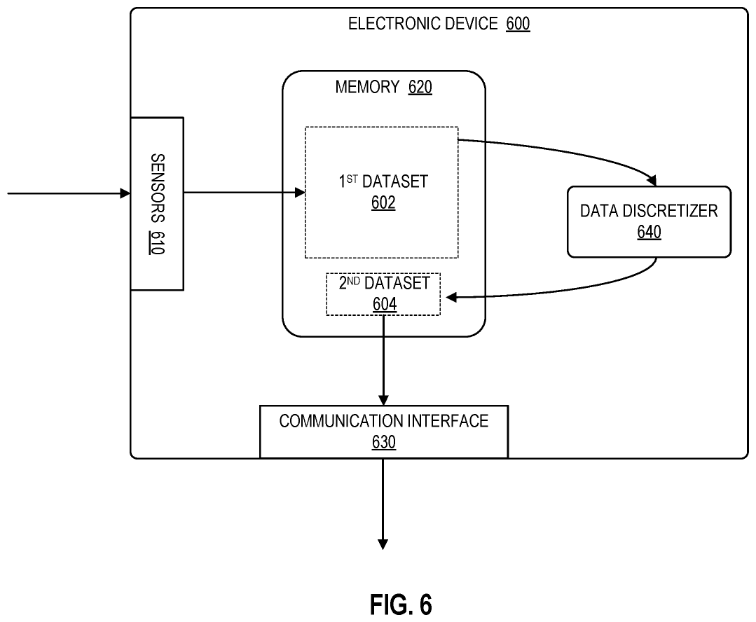

FIG. 6 illustrates an example embodiment of an electronic device 600 with data discretization functionality. In the illustrated embodiment, electronic device 600 includes sensors 610, memory 620, communication interface 630, and data discretizer 640, as described further below.

Sensor(s) 610 may include any type of sensor for monitoring, detecting, measuring, and generating sensor data and signals associated with characteristics of their environment. For instance, a given sensor 610 may be configured to detect one or more respective characteristics, such as movement, weight, physical contact, biometric properties, temperature, wind, noise, light, position, humidity, radiation, liquid, specific chemical compounds, battery life, wireless signals, computer communications, and bandwidth, among other examples. Sensors 610 can include physical sensors (e.g., physical monitoring components) and virtual sensors (e.g., software-based monitoring components).

Memory 620 may include any type or combination of components capable of storing information, including volatile and/or non-volatile storage components, such as random access memory (RAM) (e.g., dynamic random access memory (DRAM), synchronous dynamic random access memory (SDRAM), static random access memory (SRAM)), dual in-line memory modules (DIMM), read only memory (ROM), logic blocks of a field programmable gate array (FPGA), erasable programmable read only memory (EPROM), electrically erasable programmable ROM (EEPROM), flash or solid-state storage, non-volatile dual in-line memory modules (NVDIMM), storage class memory (SCM), direct access storage (DAS) memory, and/or any suitable combination of the foregoing.

Communication interface 630 may be an interface for communicating with any type of networks, devices, and/or components, including any wired or wireless interface, network, bus, line, or other transmission medium operable to carry signals and/or data. In some embodiments, for example, communication interface 630 may be an interface for communicating over one or more networks, such as local area networks, wide area networks, public networks, the Internet, cellular networks, Wi-Fi networks, short-range networks (e.g., Bluetooth or ZigBee), and/or any other wired or wireless networks or communication mediums.

Data discretizer 640 may be any component used for processing and/or discretizing datasets. In some embodiments, for example, functionality of data discretizer 640 may be implemented using any type or combination of hardware and/or software logic, such as a processor (e.g., a microprocessor), application specific integrated circuit (ASIC), field programmable gate array (FPGA), or another type of integrated circuit or computing device or data processing device, and/or any associated software logic, instructions, or code. In some embodiments, for example, data discretizer 640 may be similar to data discretizer 300 of FIG. 3.

In the illustrated example, a first dataset 602 is obtained initially. Dataset 602 may include any type of data used for any purpose, including data analytics (e.g., data mining, machine learning and artificial intelligence). In the illustrated embodiment, dataset 602 is obtained based on data generated by sensors 610. In other embodiments, however, dataset 602 can be obtained based on data provided by any source, including other devices, databases, users, networks, and so forth. For example, in some embodiments, dataset 602 may be obtained over a network (e.g., via communication interface 630).

In some embodiments, some or all of dataset 602 may initially be stored in memory 620. For example, in some cases, the entire dataset 602 may be stored in memory 620 (e.g., if sufficient memory capacity is available and/or dataset 602 is not excessive in size), while in other cases, only the portion of dataset 602 currently being processed may be stored in memory 620 (e.g., if memory capacity is limited and/or dataset 602 is excessive in size).

Dataset 602 may then be processed by data discretizer 640, for example, by performing data binning to reduce the size of the dataset. Data discretization or data binning, for example, may involve converting or partitioning a range of continuous raw data into a smaller number of “bins” that each represent a particular interval or range, and then maintaining only the bin counts, or the number of data elements in each bin. In this manner, the raw data values are aggregated and the size of the dataset is reduced or compressed. Accordingly, in the illustrated embodiment, data discretizer 640 performs data binning to reduce the size and/or compress the first dataset 602 into a second “binned” dataset 604. Moreover, in some embodiments, data discretizer 640 may determine an optimal bin size for performing the data binning, as described throughout this disclosure. For example, data discretizer 640 may identify an optimal bin size for generating a binned dataset 604 that provides a meaningful summary of the first dataset 602 without significantly deviating from the original data distribution of the first dataset 602. In this manner, the first dataset 602 is converted into a smaller compressed second dataset 604, or an efficiency vector, which can be stored and/or processed more efficiently and still maintains the important characteristics of the original dataset 602 (e.g., data distribution). Accordingly, the second dataset 604 removes a level of precision of the original dataset 602 that is both unnecessary and counterproductive to any subsequent processing and analysis.

The second binned dataset 604 may then be stored, transmitted, and/or used for further analysis and processing (e.g., or data mining or machine learning and artificial intelligence). For example, in some embodiments, the second dataset 604 may be stored in memory 620 using less memory space than would be required for the first dataset 602. The second dataset 604 may be transmitted over a network (e.g., via communication interface 630) using less transmission bandwidth than would be required for the first dataset 602. Moreover, the second dataset 604 can also be processed and/or analyzed more efficiently. In this manner, data binning can be used to increase memory availability for a device and/or reduce its memory requirements, preserve network bandwidth, and/or process data more efficiently.

### Optimized Decision Tree Machine Learning

Machine learning (ML) classifiers can be leveraged for a variety of applications and use cases. In some cases, for example, ML classifiers may be used to detect or predict failures in various types of devices and equipment (e.g., industrial, enterprise, and/or consumer-grade), such as heating, ventilation, and air conditioning (HVAC) systems (e.g., fans and compressors), robots (e.g., industrial robots used for inventory management, manufacturing, and/or semiconductor production), vehicles (e.g., cars, buses, trains, airplanes), computers and other electronic devices (e.g., computer hardware, communication networks, sensors), and so forth. It is crucial to perform fault detection as fast and reliably as possible to ensure that appropriate mitigating actions can be performed in a timely manner (e.g., to avoid any sudden failure or downtime that may cause customer dissatisfaction, physical harm, and/or associated economical losses).

This is particularly true for edge devices, which typically rely on a remote server (e.g., in the cloud) to host the ML algorithms used for fault detection. For example, the underlying hardware of compute devices at or near the edge is often resource constrained. ML classifiers used for fault detection, however, are typically highly compute- and memory-intensive. As a result, data is typically collected from edge devices (e.g., sensor/performance data) and sent to a centralized compute center with high-powered servers (e.g., a datacenter), where the data is then analyzed using ML classifiers that have been trained to perform fault detection. The outputs of the ML classifiers (e.g., fault/failure predictions) are then sent back to the edge devices over a network.

Solutions that use this approach suffer from numerous disadvantages, however, including: (i) dependency on a datacenter for monitoring device health; (ii) dependency on a reliable network connection or Internet Service Provider (ISP) to transport device data from the edge to a remote datacenter; (iii) consumption of expensive network bandwidth for transmitting large volumes of device data and/or telemetry data to the datacenter, which decreases the available bandwidth for real workloads; and (iv) increased latency for obtaining the response or output from an ML classifier due to network delays, which increases the risk of device failures and may lead to sudden interruptions in service.

Further, training a general-purpose ML model in a generic manner for all deployments of a particular edge device does not provide optimal performance. For example, individual deployments of an edge device typically vary from one deployment to another, as each deployment may have variations in the device make/model, sensor accuracies and precision, configuration, deployment conditions, and so forth. Moreover, any change in the edge deployment (e.g., changes in configuration, device, sensor type, or wear and tear due to age) requires the ML model to be retrained to ensure optimal performance. As a result, a “one size fits all” general-purpose ML model trained and hosted in the cloud does not provide optimal performance across a diverse universe of edge deployments. Further, scalability is also crucial for mass deployment of ML inference engines on edge devices of different types (e.g., makes/models) running under different environmental and operational conditions. However, using existing solutions, individually training a ML model for each specific edge deployment, along with updating/retraining the model whenever the deployment changes, is often infeasible or impractical. As a result, existing solutions are not suitable for large-scale training and deployment of custom ML models across many different edge deployments in a highly efficient and scalable manner.

Accordingly, this disclosure presents embodiments of an optimized decision tree ML classifier (e.g., a random forest classifier) that is suitable for large-scale training and deployment on resource-constrained devices, such as edge devices, as described further below.

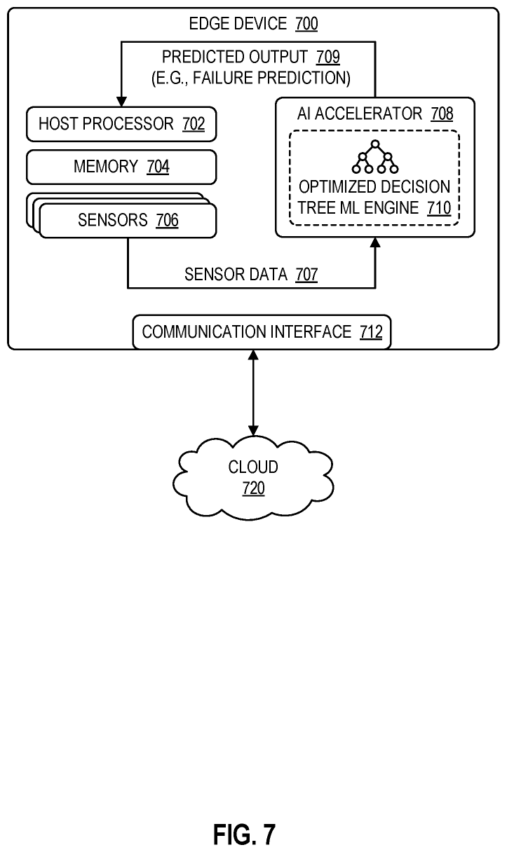

FIG. 7 illustrates an example embodiment of an edge device 700 with an optimized decision tree machine learning (ML) engine 710. The optimized decision tree ML engine 710 enables machine learning training and inference algorithms to be efficiently performed at the edge for a variety of applications and use cases, such as fault detection, as described further below.

Edge device 700 may be or may include any type of device or equipment deployed at or near the edge of a network or system (e.g., HVAC equipment, manufacturing equipment, medical devices, computing and/or networking equipment, cameras). In the illustrated embodiment, edge device 700 includes a host processor 702, a memory and/or data storage 704, a collection of sensors 706, an artificial intelligence (AI) accelerator 708, and a communication interface 712.

The collection of sensors 706 is used to capture sensor data 707 associated with the operating environment of the edge device 700, such as data associated with the operation or health of the device 700 itself and/or its underlying components, its physical environment, and so forth.

Moreover, the AI accelerator 708 is implemented with an optimized decision tree machine learning (ML) engine 710, which is used to detect or predict failures associated with the edge device 700 based on the sensor data 707 captured by the sensors 706 (either alone or in conjunction with other types of data). In particular, the decision tree ML engine trains a decision tree machine learning model, such as a random forest model, to predict the health of the edge device 700 based on past sensor data 707 captured for various known or “ground truth” health states of the device 700 (e.g., device healthy, present failure of component X/Y/Z, imminent failure of component X/Y/Z, etc.). The decision tree ML engine can then use the trained decision tree model to classify or infer the current health of edge device 700 based on newly captured sensor data 707. In this manner, the decision tree ML engine can detect or predict failures 709 associated with the edge device 700 in real time based on its current health as determined based on the decision tree ML model.

When a failure is predicted by the decision tree ML engine, the AI accelerator 708 provides the failure prediction 709 to the processor 702, which may then perform and/or trigger any appropriate mitigating or remedial actions in response to the predicted failure (e.g., notifying a cloud-based server 720 and/or other edge devices of the failure via communication interface 712, activating redundant or backup devices or components, migrating workloads to other edge devices).

In the illustrated embodiment, the optimized decision tree ML engine 710 performs training and inference using decision tree machine learning algorithms (e.g., random forest) implemented in a highly efficient manner, which reduces compute cycle requirements and memory resource requirements by manifolds. As a result, the decision tree machine learning algorithms are suitable for deployment at the edge and/or on resource-constrained devices (e.g., on FPGAs, ASICs, co-processors, smartNICs, and so forth). In particular, the decision tree ML engine 710 leverages the optimized data quantization and data binning method described throughout this disclosure (particularly in connection with FIGS. 1-6) to significantly reduce the training time for training a decision tree machine learning model, such as a random forest model. The training time is reduced by 3×-5× both in the cloud and at the edge, the number of parallel compute blocks is reduced on the order of more than 100×, and memory requirements are reduced by ˜1000× in a fixed memory architecture (e.g., on an FPGA).

Further, this solution provides a way of deploying ML classifiers at FPGAs or at any edge device without the need to host them on a remote server (e.g., in the cloud) and communicate over already overloaded network bandwidth. This solution also reduces the response time of the machine learning models, enabling real time operation and mitigation of risks and failures on time. For example, the solution enables an edge-based architecture utilizing the adjacent acceleration or a smartNIC device to provide analytics functionality (e.g., failure prediction/fault detection) using telemetry data available at the edge without sending it to a central office or cloud. Having the analytics and inference engine at the edge reduces the latency of failure prediction and mitigation as a result of usage of local telemetry data without traversing it to and from the cloud-based management stack. The edge-based solution leveraging predictive analytics can be deployed as a stand-alone solution for self-managing devices, or can be deployed with a datacenter management stack to achieve a self-driving datacenter. Further, the solution enables models to be individually or custom trained per-device rather than generically training general-purpose models for many different devices. This solution also provides fast results and closed-loop mitigation.

The decision tree ML engine 710 is suitable for deployment on edge devices and other resource-constrained devices, or in the cloud, using FPGAs, ASICs, coprocessors, smartNICs, and/or any other general-purpose and/or special-purpose processors and accelerators. In some embodiments, for example, the decision tree ML engine 710 may be deployed on an FPGA (with an on-board edge memory) of an edge computing device 700.

Moreover, the decision tree ML engine 710 can be used to implement any machine learning application or use case that relies on decision tree machine learning (e.g., fault detection, medical diagnostics, etc.). The decision tree ML engine 710 may be implemented using any type or combination of decision tree machine learning algorithms, including random forests, centered forests, uniform forests, rotation forests, ensemble decision trees, boosting trees, bagging trees, classification and regression trees (CART), conditional inference trees, fuzzy decision trees (FDT), decision lists, iterative dichotomiser 3 (ID3), C4.5, chi-square automatic interaction detection (CHAID), and multivariate adaptive regression splines (MARS), among other examples.

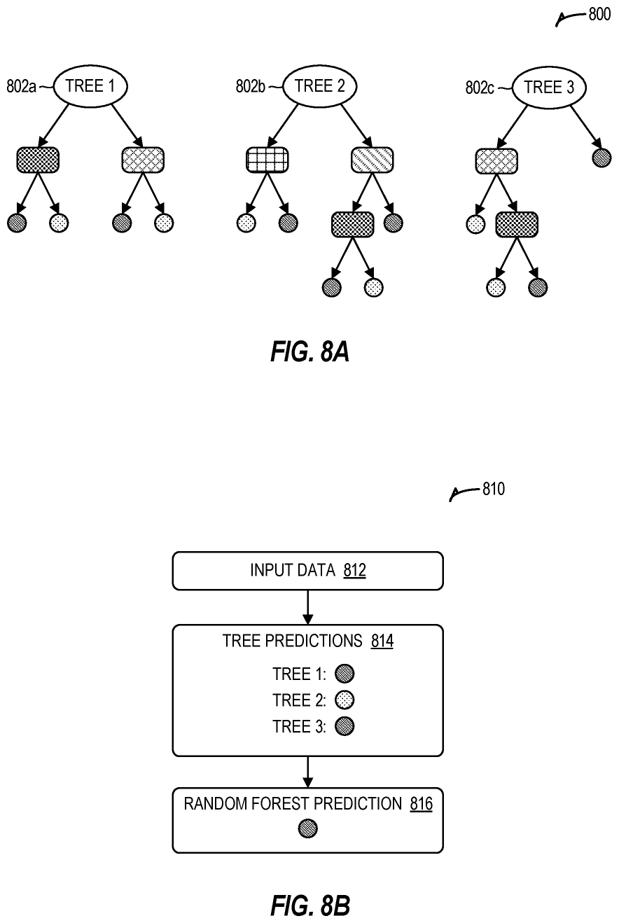

The optimized decision tree machine learning solution is described further in connection with FIGS. 8-13.

FIGS. 8A-B illustrate an overview of a random forest machine learning (ML) algorithm. In particular, FIG. 8A illustrates an example of a trained random forest model 800, and FIG. 8B illustrates an example process flow 810 for performing inference (e.g., classification and/or regression) using the trained random forest model 800.

A random forest algorithm is a supervised machine learning algorithm that trains or generates multiple individual decision trees (e.g., binary trees) using some level of randomization and then uses them together as an ensemble to perform inference (e.g., classification and/or regression). For example, to perform inference, each individual tree of the random forest generates a prediction, and the random forest then uses the respective predictions from the individual trees to determine and output a final prediction. In some embodiments, for example, a random forest trained to perform classification may output the predicted class or label corresponding to the mode of the classes predicted by the individual trees (e.g., the class with the most predictions), while a random forest trained to perform regression may output a predicted numerical value corresponding to the mean (e.g., average) of the values predicted by the individual trees. The fundamental concept behind a random forest is that ensemble predictions from a large number of relatively uncorrelated decision trees will be more accurate than predictions from any of the individual trees. The number of trees in the random forest can be configurable, and the accuracy of the ensemble predictions will typically increase and decrease with the number of trees (e.g., the more trees in the random forest, the higher the accuracy of the ensemble predictions).

An example of a trained random forest model 800 is shown in FIG. 8A. In the illustrated example, the random forest model 800 only includes three decision trees 802a-c for the sake of simplicity. In actual embodiments, however, a random forest model may contain any number of decision trees (e.g., 50-100 trees in some cases).

An example process flow 810 for performing inference (e.g., classification or regression) using the trained random forest model 800 is shown in FIG. 8B. In the illustrated example, at block 812, the random forest model 800 is supplied with new input data on which inference is to be performed. For example, the input data may include newly captured, previously unseen, and/or unlabeled sensor data that needs to be classified or labeled. At block 814, each tree 802a-c of the random forest model 800 performs inference on the input data to generate a corresponding prediction associated with the input data. In the illustrated example, trees 1 and 3 generated the same prediction while tree 2 generated a different prediction. At block 816, the random forest outputs a final prediction based the underlying predictions from the respective trees. In the illustrated example, the random forest outputs the prediction generated by trees 1 and 3 since it received the most votes.

The training algorithm for a traditional random forest model performs the following steps to generate each individual tree of the model:
1. Create multiple training sets of size N by sampling the original training data according to some sampling distribution (e.g., bagging or boosting).
   a. The same number of data points is used to create multiple trees (this is more of CART (Classification and Regression Trees)).
2. Choose a particular number of features (e.g., two features) at random from M features in the feature set in the training/child node data.
   a. Sort the training set with respect to the feature value.
   b. For each value of the feature, divide or partition the training set/child node data into greater and lesser value child datasets.
   c. For each child dataset, compute the child and total Gini index based on the labels of the data in the child dataset (see equation (2) below for computing a Gini index).
   d. Repeat the steps 2(b)-(c) for each value of each randomly selected feature, and select the corresponding feature and cutoff value having the best Gini index.
   e. Based on the selected cutoff value of the selected feature, divide the feature data set for the current node into two child node data sets whose values are respectively less than, and greater than or equal to, the cutoff value of the selected feature.
3. Repeat step 2 until all data points in the child data set have the same label or there is only one data point remaining in the child data set. These nodes are called leaf nodes.

For example, after the training data is sampled into multiple groups (e.g., each group for generating a different tree of the random forest), a certain number of features (e.g., two features) is chosen randomly from the M features in the feature set. For each randomly selected feature, each value of the feature is tested to determine if it is a good cutoff point for splitting the data. The goodness of the cutoff point is measured using a Gini index measure (equation (2)). The cutoff point with the highest Gini index is chosen. The creation of new nodes continues in this manner until each leaf node only has data of the same class/label or only has one data point.

The Gini index for training data T with n classes is defined as:

Gini(T)=1−Σⱼ₌₁ⁿ(pⱼ)² (2)

where pⱼ is the relative frequency of class j in data T.

The traditional random forest method described above sorts each attribute and computes Gini indexes (children Gini and Total Gini) for each value of the attribute to identify the best cutoff point. For example, if there are 12,000 samples in a training set, the traditional method computes Gini for each of the 12,000 values, irrespective of its value, to identify the best cutoff value which divides the data best into two different classes or labels. This process is very compute intensive and requires significant computation time, particularly in view of the large sizes of training data that are typically used to train machine learning models. Additionally, sorting is a highly compute intensive and serial function, and thus does not benefit much from the parallel computation capabilities of FPGAs that are generally used to accelerate machine learning applications.

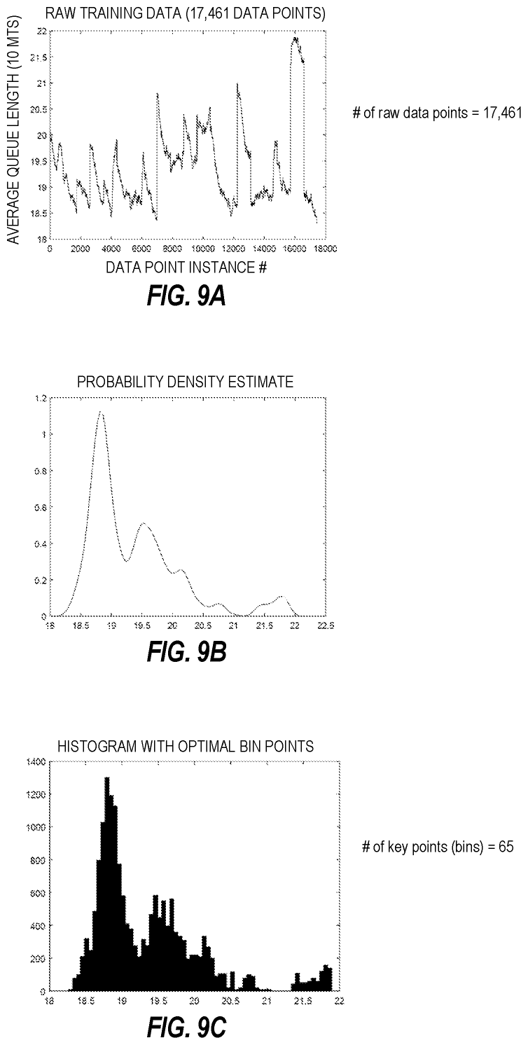

Accordingly, this disclosure presents an efficient training algorithm for a decision tree (e.g., a random forest) that optimizes the best cutoff point selection process. In particular, only a few key predetermined points are examined for the cutoff point selection process, which are determined using the automated data discretization and binning algorithm described above in connection with FIGS. 1-6. For example, the algorithm does not compute Gini for each and every value of a feature to identify the best cutoff point; instead, it computes Gini for specific values of a feature, which are predetermined using the automated quantization, discretization, and data binning method discussed above. An example of using this automated binning method to determine the key check points (or bins) is shown in FIGS. 9A-C.

As a result, this solution reduces the execution time by ˜5× for the root node and ˜4× for an entire tree without any meaningful performance hit to the resulting tree. It also reduces the compute resources required for parallelizing the best cutoff point selection algorithm by over 100× since the number of Gini computations is limited to a few key points (e.g., ˜65 points instead of 17,461) and thus so are the comparisons for a multiple feature set. Moreover, this solution removes the need for sorting each feature, which consumes significant compute resources (e.g., O(n*n) to O(n*log(n)) CPU cycles based on the implementation), and alleviates a highly serial method that consumes exclusive hardware. As a result, this solution enables efficient implementations of decision tree machine learning algorithms (e.g., random forest) in parallel architectures such as FPGAs. For example, by using the binning algorithm, the number of Gini computations is very minimal and can be further sped up by parallelism, as each computation of Gini is independent. Moreover, the binning algorithm just needs a comparator to generate a histogram. By comparison, for the traditional random forest algorithm, parallelism is impractical because the number of Gini computations is equivalent to the number of data points in the training data, which is often very large. Further, in this solution, the Gini coefficient is used to calculate entropy rather than information gain-no log values are required and Gini is simple in terms of multiplication and addition.

Moreover, in addition to the benefits of removing the sorting requirement and reducing the number of Gini computations, the termination criteria for declaring a leaf node can also be optimized in this solution. For example, this solution enables the minimum number of samples in a leaf to be optimized (which is fixed at 1 in the traditional random forest algorithm), along with the minimum number of samples in an impure node for it to be considered for splitting (which is fixed at 2 in the traditional random forest algorithm).

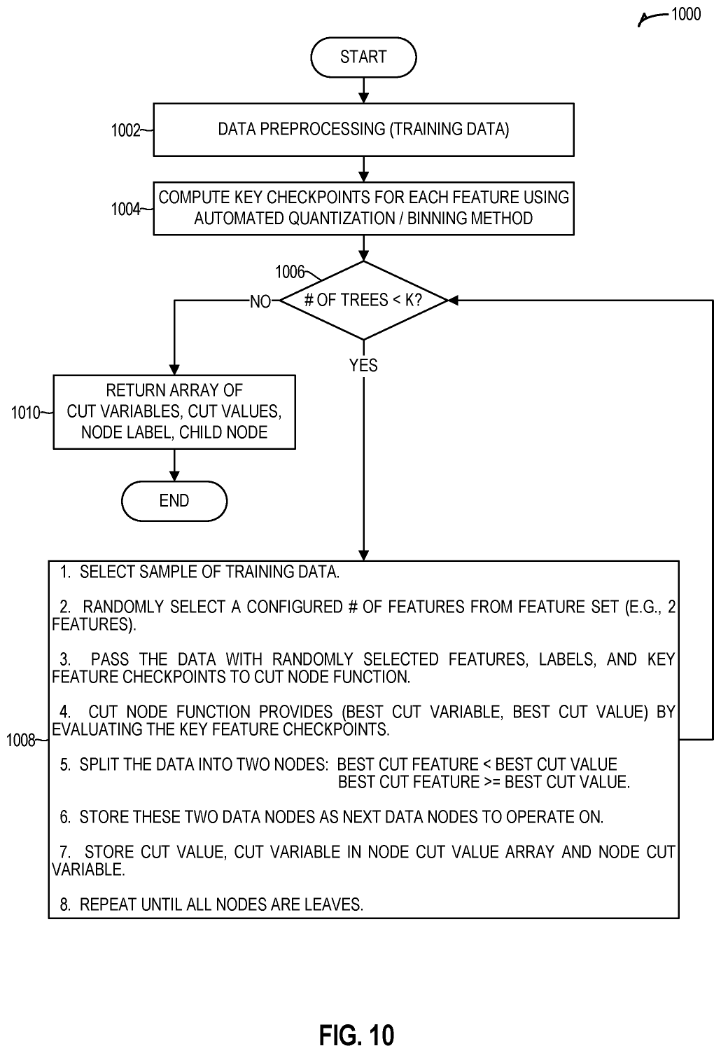

FIG. 10 illustrates a process flow 1000 for efficiently training a random forest machine learning (ML) model in accordance with certain embodiments.

The process flow begins at block 1002, where data preprocessing is performed on the training data (e.g., data filtering, denoising, normalization, interpolation, extrapolation).

The process flow then proceeds to block 1004 to compute key checkpoints for each feature using the automated quantization/binning algorithm described throughout this disclosure.

The process flow then proceeds to block 1006 to determine if the number of decision trees that have been generated is less than the required number of trees (K) for this particular random forest model (e.g., K=50 for a random forest with 50 trees).

If the requisite number of trees (K) have been generated, training is complete and the process flow proceeds to block 1010 to return a representation of the random forest (e.g., an array of cut variables, cut values, node label, child node).

If the requisite number of trees (K) have not yet been generated, the process flow proceeds to block 1008 to generate another decision tree for the random forest by performing the following steps:
1. Select a sample of training data.
2. Randomly select a configurable number of features (X) from the feature set (e.g., for X=2, two features will be randomly selected).
3. Pass the data with the randomly selected features, labels, and key feature checkpoints to a cut node function.
4. The cut node function outputs (best cut variable, best cut value) by evaluating the key feature checkpoints.
5. Split the data into two nodes: best cut feature<best cut value
   best cut feature>=best cut value.
6. Store these two data nodes as the next data nodes to operate on.
7. Store the cut value, cut variable in node cut value array and node cut variable.
8. Repeat until all nodes are leaves.

The process flow repeats in this manner until the required number of trees for the random forest model have been generated.

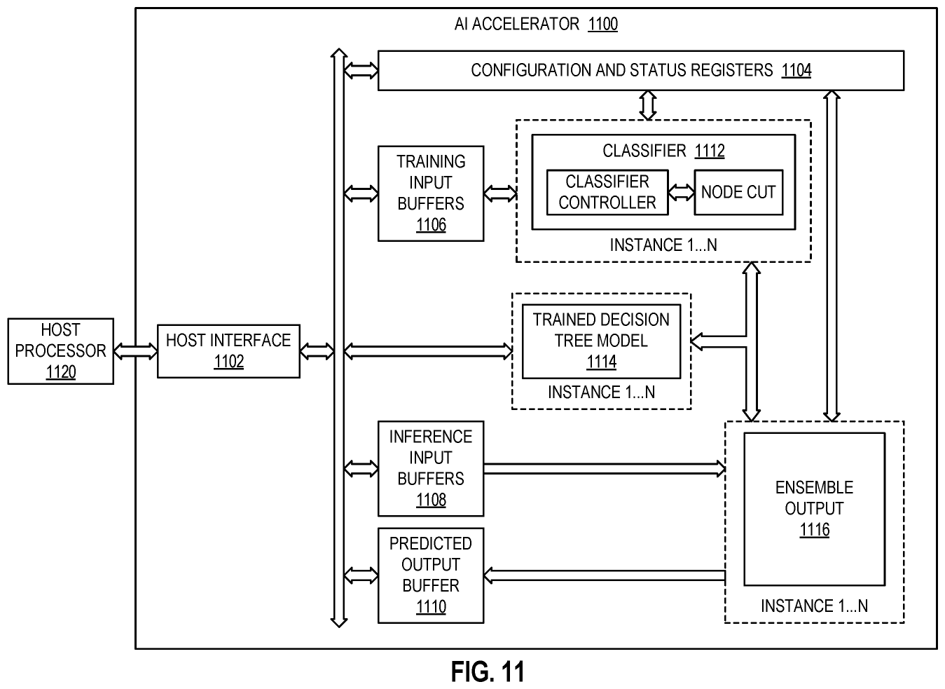

FIG. 11 illustrates an example embodiment of an artificial intelligence (AI) accelerator 1100 implemented with an optimized decision tree machine learning (ML) engine. AI accelerator 1100 may be a special-purpose processor or accelerator implemented on an FPGA, ASIC, and/or any other suitable type of integrated circuit or processing circuitry. In some embodiments, for example, the components of AI accelerator 1100 may correspond to the compute blocks of an FPGA implemented with an optimized decision tree ML engine. Moreover, in some embodiments, AI accelerator 1100 may be used to efficiently implement a decision tree machine learning (ML) model, such as a random forest model, for an edge device and/or other resource-constrained or resource-sensitive device (e.g., similar to AI accelerator 708 of edge device 700 from FIG. 7).

In the illustrated embodiment, AI accelerator 1100 includes host interface 1102, configuration and status registers 1104, training input buffers 1106, inference input buffers 1108, predicted output buffer 1110, classifier 1112, trained decision tree ML model 1114, and ensemble output module 1116.

The host interface 1102 enables the AI accelerator 1100 to communicate with a host processor 1120 (such as processor 702 of edge device 700 from FIG. 7). For example, the host interface 1102 may be used to read and write configuration and status information via the configuration/status registers 1104, read and write training and inference data via the training input buffers 1106 and inference input buffers 1108, read and write inference predictions and outputs via the predicted output buffer 1110, and so forth.

In some embodiments, for example, the training data used to generate the decision tree ML model 1114 may be sent from the host processor 1120 to the AI accelerator 1100 via the host interface 1102, and then stored in the training input buffers 1106 of the AI accelerator 1100.

Further, in some embodiments, the optimal bin cutoff points for each feature of the training data (e.g., to be evaluated during generation of the decision tree) may be computed by the host processor 1120, sent to the AI accelerator 1100 via the host interface 1102, and stored in the configuration/status registers 1104 and/or training input buffers 1106 of the AI accelerator 1100. In other embodiments, however, the AI accelerator 1100 may directly compute the optimal bin cutoff points (e.g., via logic/circuitry implemented by the classifier module 1112) using the training data supplied by the host processor 1120 and stored in the training input buffers 1106.

The configuration and status registers 1104 may further be used to store any other configurable parameters or status information associated with training the decision tree ML model 1114 and/or performing inference/classification using the model 1114.

The classifier 1112 includes a main classifier controller and a node cut module, which are collectively used to efficiently generate a trained decision tree ML model 1114 in the manner described throughout this disclosure (e.g., using the training data from the host processor 1120 and the optimal bin cutoff points computed for each feature of the training data). In some embodiments, for example, the trained decision tree ML model 1114 may be a random forest model.

The trained decision tree model 1114 can then be used to perform inference and/or generate predictions for new data supplied by the host processor 1120 via the inference input buffers 1108. In some embodiments, for example, the new data may include newly captured and/or previously unseen data that has not yet been classified or labeled. Accordingly, the ensemble output module 1116 may use the trained decision tree model 1114 to classify or label the new data. For example, with respect to a random forest model 1114, the ensemble output module 1116 obtains a prediction regarding the class or label of the new data from each decision tree in the random forest, and the ensemble output module 1116 then determines a final prediction based on the collective predictions from the various trees. The final prediction from the ensemble output module 1116 is then stored in the predicted output buffer 1110 for subsequent retrieval by the host processor 1120 via the host interface 1102.

In some embodiments, multiple instances of certain components may be implemented on AI accelerator 1100 in order to parallelize training and/or inference computations. In the illustrated embodiment, for example, AI accelerator 1100 includes multiple instances (e.g., instances 1 . . . N) of classifier 1112, decision tree model 1114, and ensemble output module 1116.

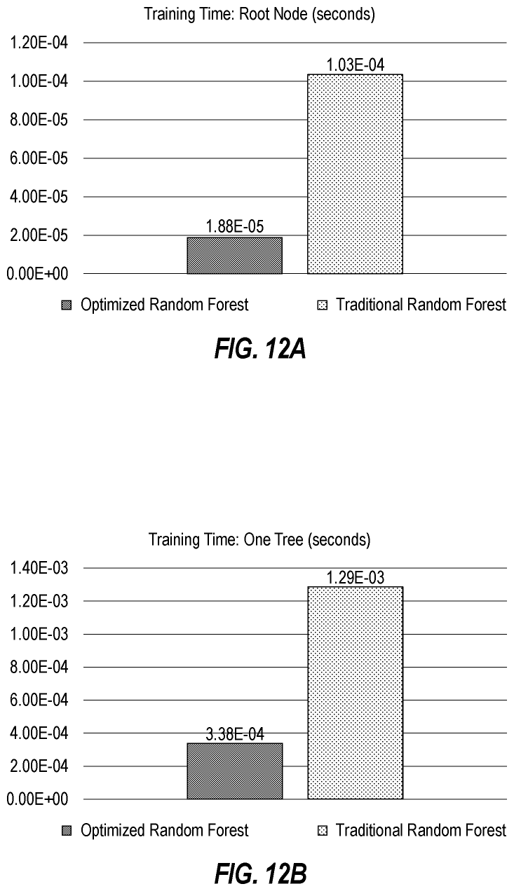

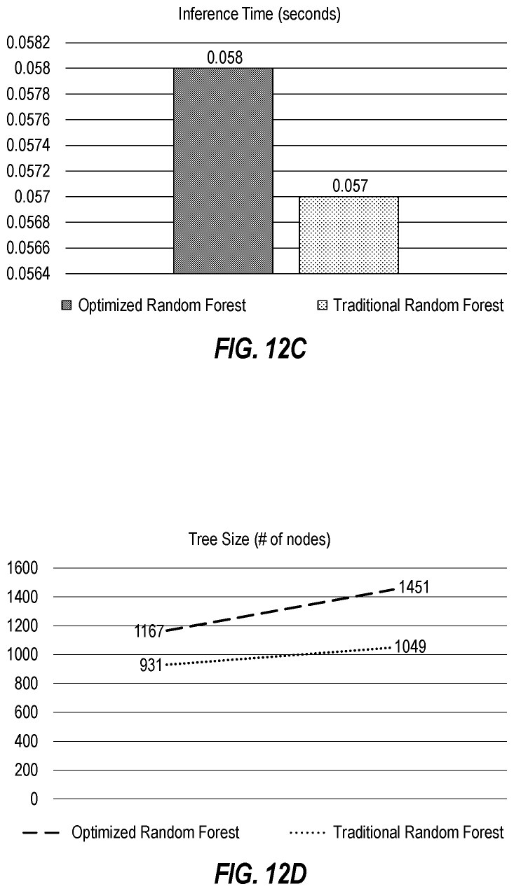

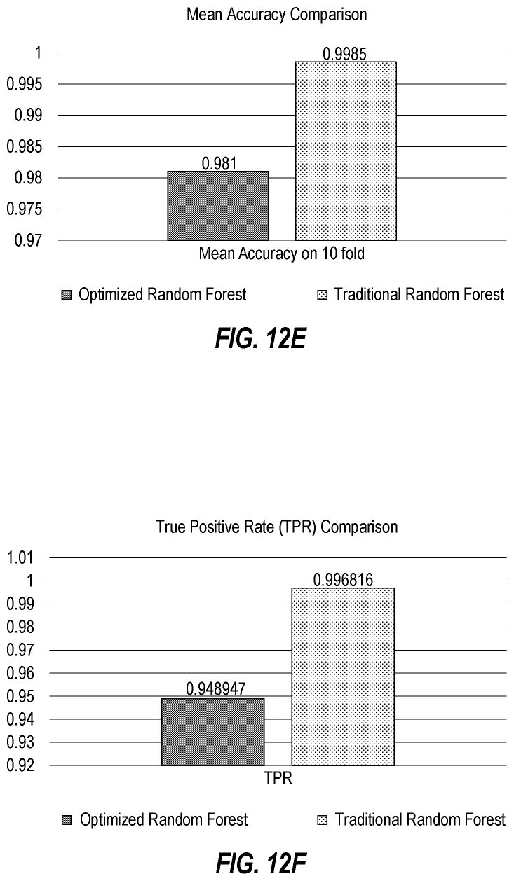

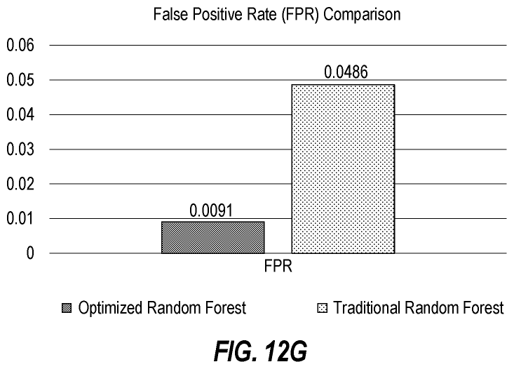

FIGS. 12A-G illustrate a performance comparison of an optimized random forest versus a traditional random forest implemented with sorting. In particular, FIG. 12A illustrates a graph comparing the training time for a root node of a tree, FIG. 12B illustrates a graph comparing the training time for an entire tree, FIG. 12C illustrates a graph comparing the inference time, FIG. 12D illustrates a graph comparing the tree size (e.g., the number of tree nodes), FIG. 12E illustrates a graph comparing the mean inference accuracy, FIG. 12F illustrates a graph comparing the true positive rate (TPR) for inference, and FIG. 12G illustrates a graph comparing the false positive rate (FPR) for inference.

The illustrated performance comparison is based on a training dataset of 12,222 data elements with five features or attributes. Tree formation (e.g., training) for the traditional random forest involved 12,222 Gini computations, while tree formation for the optimized random forest involved only 65 Gini computations. This reduced the training execution time (e.g., tree formation) by a factor of approximately five (˜5× reduction) for a root node and a factor of approximately four (˜4× reduction) for an entire tree. The inference time and the size of the tree were comparable for both random forest models. The inference performance was also comparable for both random forest models: the classification accuracy was 98% for the optimized random forest and 99% for the traditional random forest, the true positive rate (TPR) was 94% for the optimized random forest and 99% for the traditional random forest, and the false positive rate (FPR) was less than 1% for the optimized random forest and 4% for the traditional random forest.

Overall, the optimized random forest significantly reduces the execution time for tree formation and training due to the reduced number of Gini computations and elimination of the sorting step, which similarly reduces the hardware resource requirements and costs for hardware-based implementations on FPGAs, ASICs, and/or other types of compute hardware. These performance and cost benefits of the optimized random forest significantly outweighs its slight reduction in inference accuracy compared to the traditional random forest. Further, due to the significantly reduced number of Gini computations (e.g., from 12,222 down to 65), the optimized random forest method makes it feasible to parallelize the Gini computations on hardware-based implementations (e.g., FPGAs), which further reduces the execution time for training the model.

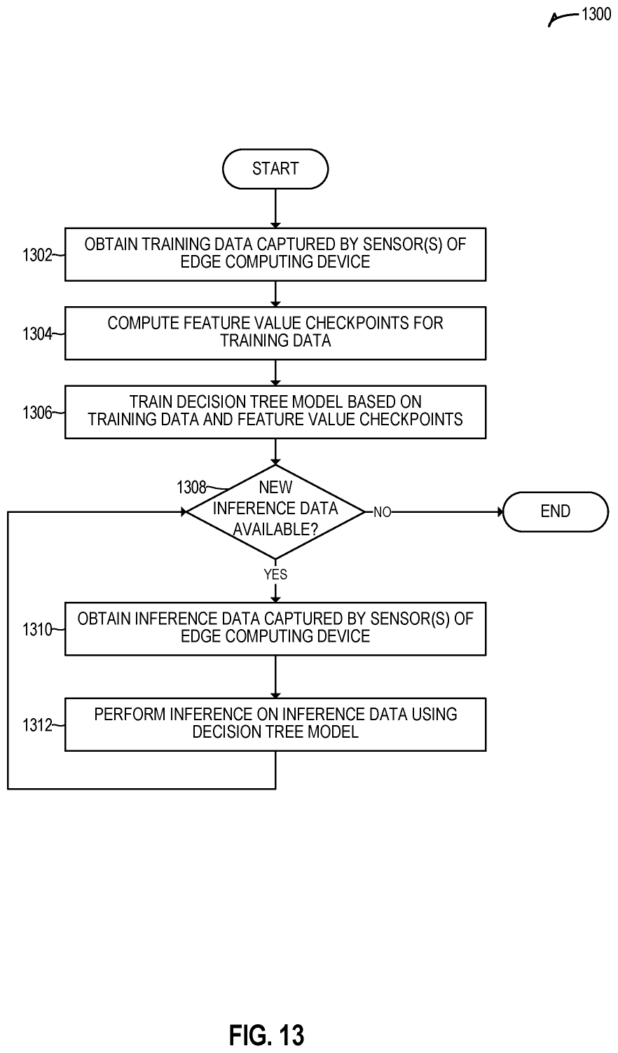

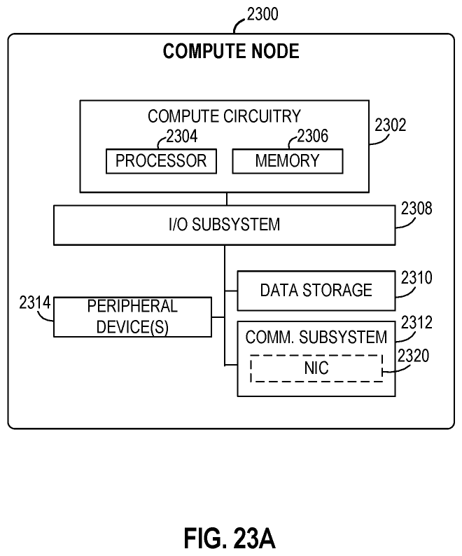

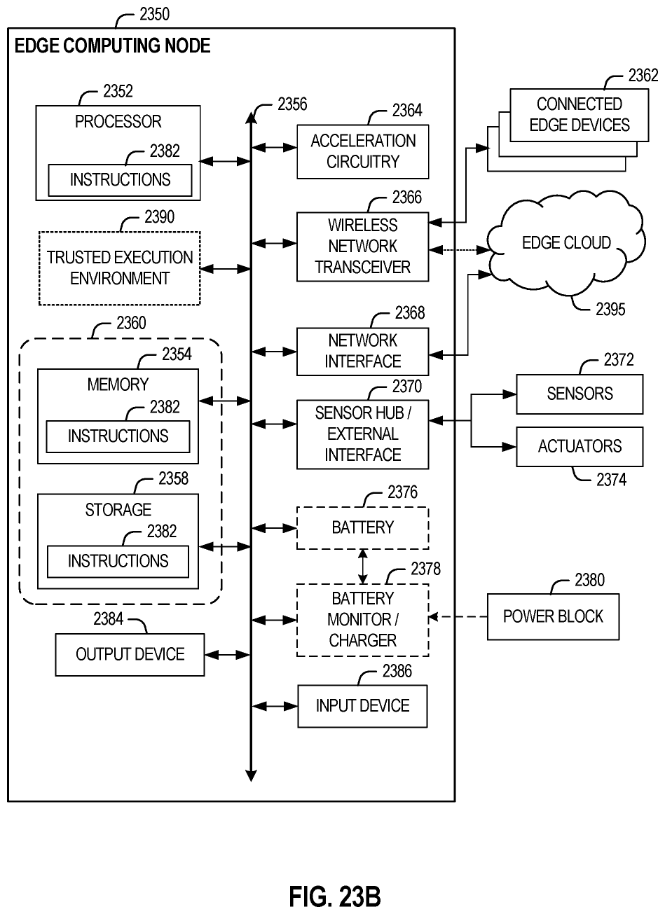

FIG. 13 illustrates a flowchart 1300 for performing decision tree training and inference in accordance with certain embodiments. In some embodiments, flowchart 1300 may be implemented and/or performed by or using the computing devices, systems, and/or platforms described throughout this disclosure (e.g., edge device 700 of FIG. 7, AI accelerator 1100 of FIG. 11, compute nodes 2300, 2350 of FIGS. 23A-B, and so forth).

The flowchart begins at block 1302 to obtain training data for an edge computing device. The training data corresponds to a plurality of labeled instances of a feature set, which may be captured at least partially by one or more sensors of the edge computing device. In some embodiments, the training data may be received over an interface, such as a host interface between an artificial intelligence accelerator and a host processor of the edge computing device, a network interface, a sensor interface, and so forth.

The flowchart then proceeds to block 1304 to compute or obtain feature value checkpoints for the training data, which will be used to train a decision tree model (e.g., a random forest model). For example, the feature value checkpoints may indicate, for each feature of the feature set in the training data, a subset of potential feature values to be evaluated for splitting tree nodes of a decision tree model during training.

In some embodiments, for example, the feature value checkpoints may be computed for each feature of the feature set by: determining an optimal bin size for binning a set of feature values contained in the training data for a corresponding feature of the feature set; binning the set of feature values into a plurality of bins based on the optimal bin size; and identifying feature value checkpoints for the corresponding feature based on the plurality of bins.

Moreover, the optimal bin size may be determined by: identifying a plurality of possible bin sizes for binning the set of feature values; computing a plurality of performance costs for the plurality of possible bin sizes; and selecting the optimal bin size from the plurality of possible bin sizes, wherein the optimal bin size corresponds to a lowest performance cost of the plurality of performance costs.

The flowchart then proceeds to block 1306 to train the decision tree model (e.g., a random forest model) based on the training data and the feature value checkpoints. For example, the decision tree model may be trained to predict a target variable corresponding to the feature set (e.g., a class label for classification, a numerical value or range for regression, and so forth). In some embodiments, for example, the decision tree model may be trained to predict failures associated with the edge computing device, and thus the target variable may indicate whether or not a failure is predicted for the edge computing device.

In some embodiments, the decision tree model may be a random forest model with a plurality of decision trees. Thus, the random forest model may be trained by generating a plurality of decision trees based on the training data and the set of feature value checkpoints.

In some embodiments, for example, each decision tree may be generated by: extracting, from the training data, a random training sample for generating a corresponding decision tree of the plurality of decision trees; generating a root node for the decision tree based on the random training sample; selecting, from the feature set, a random subset of features to be evaluated for splitting the root node; obtaining, from the set of feature value checkpoints, a subset of feature value checkpoints for the random subset of features; computing a plurality of impurity values for the subset of feature value checkpoints; selecting, from the subset of feature value checkpoints, a corresponding feature value for splitting the root node, wherein the corresponding feature value is selected based on the plurality of impurity values; and splitting the root node into a set of child nodes based on the corresponding feature value; and repeating the process for the child nodes in a recursive manner until each remaining child node is a leaf node (e.g., a node with either a single data point or multiple data points that all share the same label). In some embodiments, the plurality of impurity values may include, or be based on, a plurality of Gini indexes or computations.

The flowchart then proceeds to block 1308 to determine if new inference data is available. If no new inference data is available, the flowchart may wait at block 1308 until new inference data becomes available, or alternatively, the flowchart may end.

If new inference data is available, the flowchart then proceeds to block 1310 to obtain the inference data (e.g., received via an interface). The inference data corresponds to an unlabeled instance of the feature set, which may be captured at least partially by one or more sensors of the edge computing device.

The flowchart then proceeds to block 1312 to perform inference on the inference data using the trained decision tree model. For example, the decision tree model may be used to predict the target variable for the unlabeled instance of the feature set in the inference data.

The flowchart repeats blocks 1308-1312 in this manner to continue performing inference using the trained decision tree model as new inference data becomes available.

At this point, the flowchart may be complete. In some embodiments, however, the flowchart may restart and/or certain blocks may be repeated. For example, in some embodiments, the flowchart may restart at block 1302 to update and/or retrain the decision tree model based on new training data, and/or the flowchart may proceed to block 1308 to continue performing inference using the decision tree model as new inference data becomes available.

### Memory-Efficient System for Decision Tree Learning

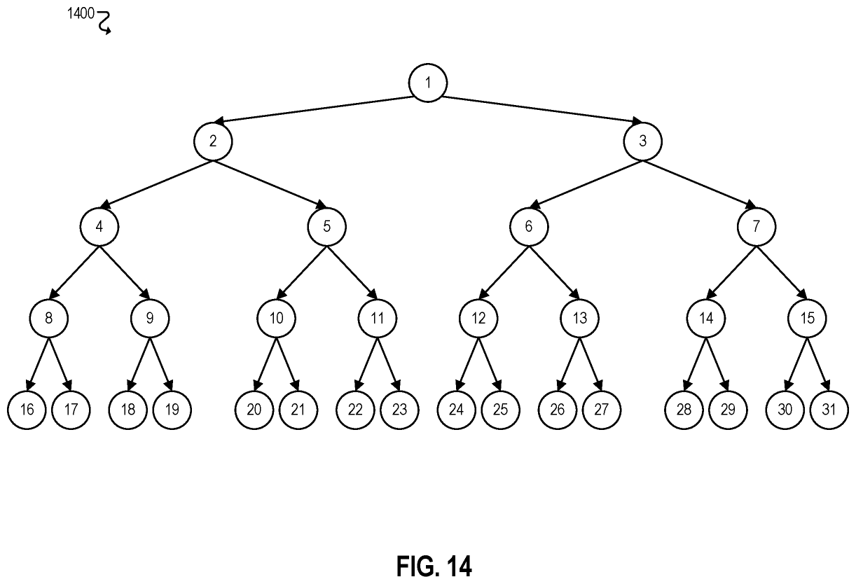

Tree data structures, such as binary trees and/or decision trees, are very common data structures that are part of many data mining, machine learning, and artificial intelligence methods, as well as many data storage architectures. For example, in computer science, a binary tree is a tree data structure in which each node has at most two children, which are referred to as the left child and the right child (e.g., as shown in FIG. 14). Binary trees (and other tree data structures) are used in a wide range of frameworks from search engines to expert systems and beyond.

As an example, a decision tree is a decision support tool that uses a tree-like model of decisions based on various parameters of interest (e.g., cost, values of certainty, and so forth), which can be represented as an instance of a binary or m tree (where m=the number of child nodes). Other examples of common tree-based frameworks include random forest machine learning classifiers and hierarchical clustering algorithms.

However, these types of tree data structures (e.g., decision trees and other types of binary trees) are quite memory inefficient on fixed-memory hardware such as FPGAs, where you have to declare the size of the child nodes up front. For example, on fixed-memory hardware (e.g., FPGAs), in order to handle the worst-case scenario for each node of a tree, all child nodes are typically declared with a size equal to the original input data (e.g., the number of data samples N) even though their actual size may be much smaller. Thus, the required memory for the tree data structure is the total number of nodes multiplied by N, or (2^{k}−1)*N, where k represents the number of layers or height of the tree.

In some embodiments, the required memory for the tree data structure can be reduced by reusing memory locations of earlier child nodes (e.g., nodes that are two layers above (k−2) the current layer (k)). Even in those embodiments, however, the tree data structure would still require a memory size of 0.75(2^{k}−1)*N. For example, it can be assumed that for any layer k of the tree, only the data from the immediately preceding layer k−1 is needed, and thus the memory used at layer k−2 can be reused or overwritten. Thus, for a tree with fixed-size nodes of size N, the required memory at any layer k of the tree is ((2^{k}−1)−(2^{k-2}−1))*N units of storage. Based on this, it can be observed that for most trees with a height of 10-20 layers, only 0.75(2^{k}−1)*N units of memory storage is required if layers are reused versus (2^{k}−1)*N if layers are not reused. For example, this can be seen from the calculations shown below in Table 1, which provides the memory requirements for a tree with fixed-size nodes and reused layers on a fixed-memory architecture (based on the height or number of layers in the tree).

TABLE 1
Memory Requirements for Conventional
Tree Implementations (e.g., with Fixed-Size
Nodes and Reused Layer Storage)
on a Fixed-Memory Architecture

| | Memory Footprint | | |
|---|---|---|---|
| # of Layers | (Units of Size N) | Total # of Nodes | Memory Footprint vs. |
| k | (2^{k} − 1) - (2^{k-2} − 1) | (2^{k} − 1) | Total # of Nodes (%) |
| 2 | 3 | 3 | 100 |
| 3 | 6 | 7 | 86 |
| 4 | 12 | 15 | 80 |
| 5 | 24 | 31 | 77 |
| 6 | 48 | 63 | 76 |
| 7 | 96 | 127 | 76 |
| 8 | 192 | 255 | 75 |
| 9 | 384 | 511 | 75 |
| 10 | 768 | 1023 | 75 |
| 11 | 1536 | 2047 | 75 |
| 12 | 3072 | 4095 | 75 |
| 13 | 6144 | 8191 | 75 |
| 14 | 12288 | 16383 | 75 |
| 15 | 24576 | 32767 | 75 |
| 16 | 49152 | 65535 | 75 |
| 17 | 98304 | 131071 | 75 |
| 18 | 196608 | 262143 | 75 |
| 19 | 393216 | 524287 | 75 |
| 20 | 786432 | 1048575 | 75 |

Thus, methods that leverage tree data structures are traditionally highly memory intensive. This forms a great bottleneck in implementing these algorithms and methods, particularly in resource-constrained devices (e.g., edge devices), from the perspective of both the required hardware real estate (e.g., silicon or chip area) and the associated financial cost.

Accordingly, this disclosure presents a solution that addresses the crucial problem of implementing tree data structures in a memory-efficient manner, such as those required in many machine learning (ML) and artificial intelligence (AI) algorithms (e.g., random forest classifiers, extra trees classifiers, decision trees, binary trees, search engines, and so forth) and associated frameworks implemented in hardware (e.g., FPGAs, ASICs).

In particular, the proposed solution provides a highly memory-efficient method for implementing these tree-based algorithms and data structures in hardware. For example, the proposed solution only requires memory of size N (where N represents the size or number of data samples in the input data) regardless of the height or number of layers kin the tree. By comparison, a tree with fixed-size nodes and reused layers requires roughly (0.75(2^{k}−1)*N) units of storage. Thus, compared to a tree with fixed-size nodes and reused layers, the proposed solution provides a reduction in memory requirements on a fixed-memory architecture on the order of

$$\frac{0.75 ( {2}^{k} - 1 ) * N}{N} = 0.75 ( {2}^{k} - 1 ) .$$

The proposed solution provides numerous advantages. For example, the proposed solution can be leveraged both in the cloud and at the edge (among other examples). For example, since the proposed solution significantly reduces the memory requirements for a tree data structure or algorithm, it enables more workloads to be run in the cloud (e.g., “more for less”).

With respect to the edge, one motivation for the proposed solution is the need for a memory-efficient machine learning classifier and training engine that can be implemented on FPGAs at the edge. For example, when using traditional methods to implement tree data structures and algorithms, even high-end FPGAs with significant compute and memory real estate fall short of the memory requirements for the trees of a typical random forest classifier. The proposed solution reduces memory on the order of 1000× for a 10-layer binary tree, however, and this reduction factor only increases with the number of layers. Thus, the proposed solution enables implementations on resource-constrained and/or fixed-memory devices, such as FPGAs, ASICs, and other edge computing devices, which enables new applications at the edge that are not otherwise possible using traditional methods. For example, using the proposed solution, a general-purpose processor (e.g., an Intel Atom processor) with an ML training engine in an FPGA can be implemented and deployed at the edge.

The proposed solution is also simple and easy to implement—with minimal additional compute logic—which significantly reduces the verification and validation effort and results in faster time to market. Moreover, the proposed solution is scalable and eliminates the need for a system architect or engineer to speculate on the memory requirements for tree-based data structures and algorithms. Further, as explained above, the proposed solution significantly reduces the memory requirements compared to any other available methods, thus rendering it ideal for implementing ML/AI algorithms in hardware, such as decision tree learning algorithms implemented on FPGAs and/or ASICs.

For example, the proposed solution provides a memory-efficient implementation of tree data structures (e.g., decision trees and/or binary trees) for machine learning/AI algorithms implemented in hardware, such as on FPGAs and/or ASICs of an edge computing device. In some embodiments, for example, the proposed solution may be used to implement the decision tree machine learning (ML) training and inference engine 710 on the AI accelerator 708 of edge computing device 700 of FIG. 7 and/or on the FPGA AI accelerator 1100 of FIG. 11.

As an example, a random forest is one of the most common machine learning algorithms and is widely used for numerous applications, but it is highly memory intensive when implemented on fixed-memory architectures or platforms such as FPGAs. The proposed solution, however, can be used to implement a random forest ML engine in a memory-efficient manner.

For example, FIG. 14 illustrates the structure of a decision tree 1400 in a typical random forest machine learning classifier. In the illustrated example, the decision tree 1400 includes nodes 1-31. Beginning with the root node (node 1), the data in each parent node is divided into child nodes, and the data in each child node is stored in an array.

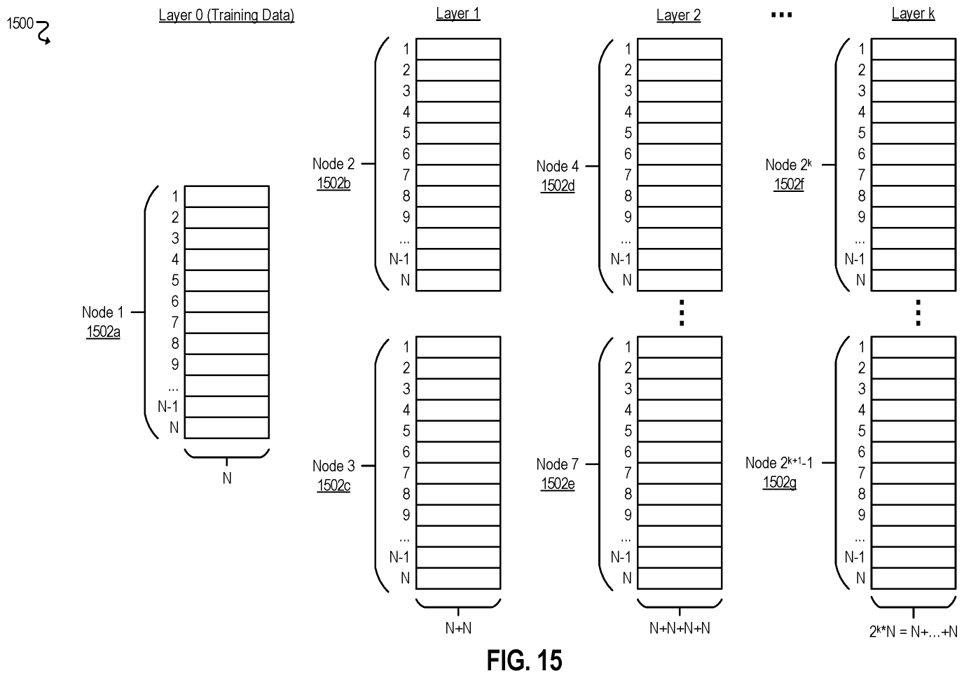

FIG. 15 illustrates the conventional implementation of a tree data structure 1500 (e.g., decision tree 1400 of FIG. 14) on a fixed-memory hardware architecture, such as an FPGA. In the illustrated example, since the memory requirement for a given node is unknown at the outset and is determined at runtime, it is impossible to decide the optimal memory size for each node. Thus, in the illustrated example, a fixed memory of size N is allocated for each node 1502a-g to account for the worst-case memory requirement. Thus, using this approach, a binary tree in fixed-memory hardware typically requires roughly N units of memory storage for each child node 1502, and since a binary tree has 2^{k}−1 nodes for a k-layer tree, the binary tree requires a total storage of (2^{k}−1)*N.

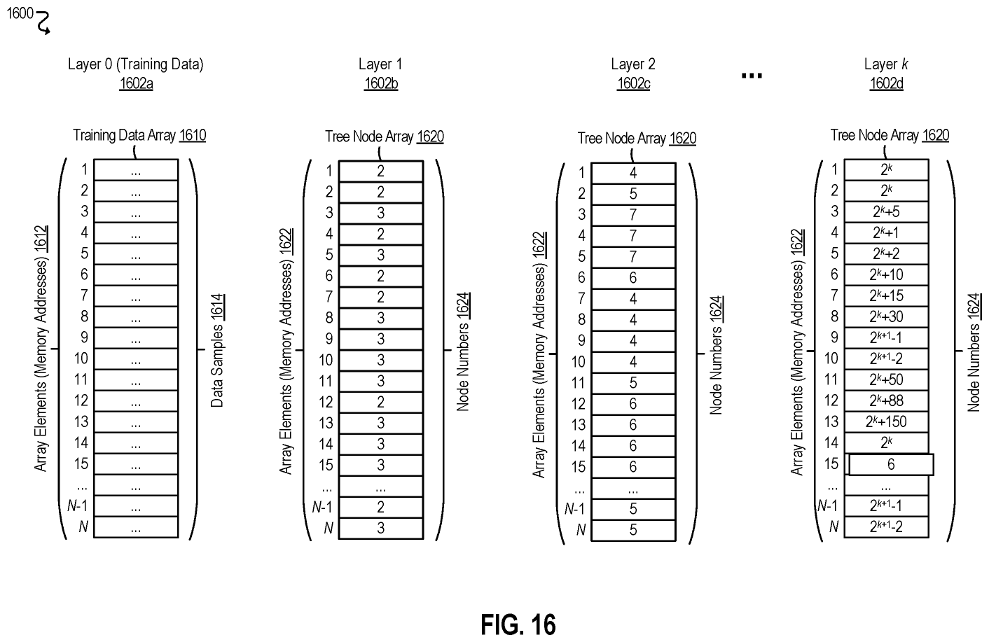

The proposed solution, however, can optimize the required storage for binary trees by a factor of 0.75× or 0.6×. For example, FIG. 16 illustrates a memory-efficient implementation of a tree data structure 1600 (e.g., a decision tree or other binary tree) in accordance with certain embodiments.

In the illustrated example, a training data array 1610 with N array elements 1612 is used to store N data samples 1614 (or pointers to those data samples). Based on the size N of the training data 1610 (where N=number of data samples), a tree node array 1620 is allocated in fixed memory with a size on the same order as the training data (e.g., a tree node array 1620 with N array elements 1622). Moreover, each element 1622 of the tree node array 1620 corresponds to one of the data samples 1614 in the training data 1610 and is used to identify the tree node 1624 assigned to the corresponding data sample 1614 throughout the tree formation process.

In some embodiments, for example, the respective layers 1602a-d of the tree are generated successively, and each tree layer 1602a-d produces at most 2^{k} to 2^{k+1}−1 nodes, where k is the tree layer number. Moreover, after the nodes are created at each layer 1602a-d, the node numbers 1624 of the tree nodes that contain or are assigned to the respective data samples 1614 are written into the respective array elements 1622 of the tree node array 1620. For example, the 1^{st} element 1622 of the tree node array 1620 stores the node number 1624 for the 1^{st} data sample in the training data array 1610, the 2^{nd} element 1622 of the tree node array 1620 stores the node number 1624 for the 2^{nd} data sample in the training data array 1610, and the N^{th} element 1622 of the tree node array 1620 stores the node number 1624 for the N^{th} data sample in the training data array 1610.

When a child node in a tree layer 1602a-d is processed for further splitting, the array elements 1622 of the tree node array 1620 are searched for the node number of that child node, and the indexes of the identified array elements 1622 containing that node number then serve as pointers to the data samples 1614 in the training data array 1610 that belong to that child node. For example, if the tree node array 1620 is searched for node number i, and that node number is found in the j^{th} element of the tree node array 1620, then the j^{th} data sample in the training data array 1610 is one of the data samples belonging to node number i.

The identified data samples 1614 of the particular child node are then split or partitioned into multiple subsets to form new child nodes (e.g., based on Gini index metrics and/or any other suitable metrics). Moreover, the node number of each new node is written into array elements 1622 of the tree node array 1620 that correspond to the data samples 1614 of the new node. This process continues until no further splitting is required (e.g., until each leaf node only contains data samples that have the same label and/or belong to the same class).

As an example, the formation of tree 1600 begins at layer 0, where the root node of the tree is represented by the entire set of training data 1610, or all N data samples.

At layer 1, the N data samples are partitioned into two subsets corresponding to two new child nodes based on a desired metric (e.g., Gini index, information gain, etc.). Moreover, in a tree node array 1620 of size N, the node numbers of the new child nodes are stored at indexes of the tree node array 1620 that correspond to the respective data samples of each child node. For example, at layer 1, node 1 (the root node) is split into child nodes 2 and 3, which each contain a corresponding subset of the data samples N. Moreover, the node numbers of the new child nodes (2 and 3) are written into the tree node array 1620 at elements or indices 1622 that correspond to the data samples in each node.

At layer 2, node 2 is split into new nodes 4 and 5, and node 3 is split into new nodes 6 and 7, each of which contains a subset of the data samples from its parent node. Moreover, the node numbers in the tree node array 1620 from the previous layer are simply overwritten with the new node numbers created in the current layer. For example, in the tree node array 1620, the array elements 1622 containing node number 2 are overwritten with node number 4 or 5, and the array elements 1622 containing node number 3 are overwritten with node number 6 or 7.

This process continues for each layer until the final layer (k) has been generated. In particular, this process continues using the same tree node array 1620 but also continues to update the node numbers to which the corresponding data samples 1614 in the training data 1610 belong.

In this manner, a single tree node array 1620 of size N is reused and overwritten as each layer of the tree is created. Thus, the tree memory size (N) is fixed and is independent of the number of layers or child nodes created during tree formation. Moreover, only minimal additional logic is needed to search and compare the node numbers during tree formation. As a result, the memory requirements for a tree are reduced from 0.75(2^{k}−1)*N down to just N when comparing the respective tree implementations of FIGS. 15 and 16.

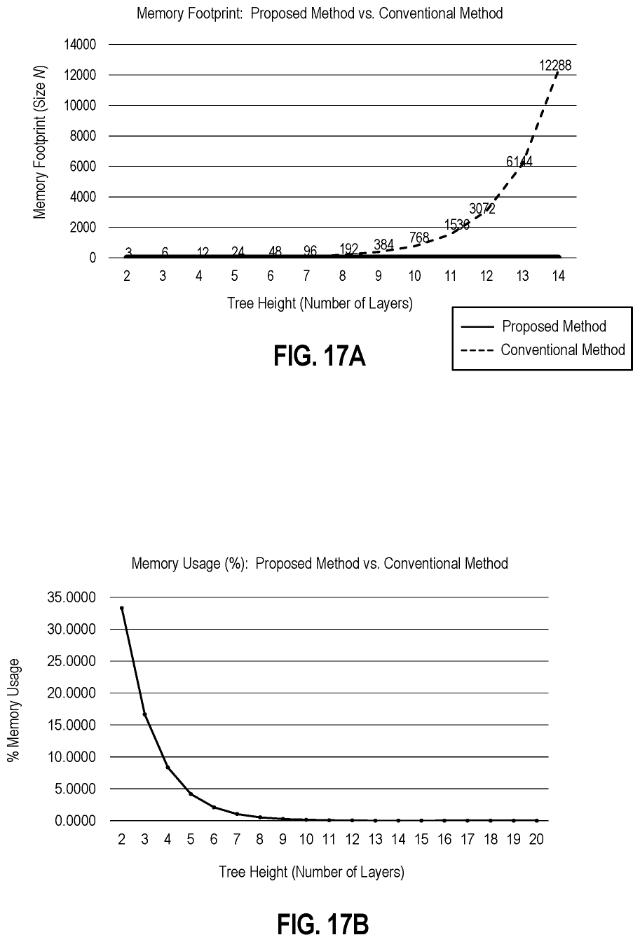

FIGS. 17A-B illustrate a memory usage comparison for tree data structures implemented using the proposed method versus the conventional method. In particular, FIG. 17A illustrates the memory usage of the proposed method and the conventional method based on the tree height (e.g., number of layers), and FIG. 17B illustrates the percentage of memory used by the proposed method versus the conventional method.

The detailed computations for the comparisons shown in FIGS. 17A-B are provided below in Table 2. In particular, Table 2 shows the respective memory usage of the proposed method and the conventional method (units of size N), and the relative percentage of memory used by the proposed method compared to the conventional method, based on the height or number of layers in the tree (k).

For example, for a tree with 10 layers (k=10), the proposed method requires only 0.13% of the memory required by the conventional method. Thus, assuming a tree implemented using the conventional method requires 10000 units of memory, the same tree would require only 13 units of memory using the proposed method, which is a reduction on the order of 1000×. This reduction in memory increases with the height of the tree (k), as shown in FIGS. 17A-B and Table 2.

As another example, for a 10-layer binary tree (k=10) with 10000 input data points or samples (N=10000) implemented on an FPGA with a total memory of 2713*2 KB=5,426,000 bytes, the conventional fixed-memory method would require (2¹⁰−1)*0.75*10000=7,672,500 bytes of memory, which exceeds the capacity of the FPGA, while the proposed method would require only 10000 bytes of memory.

Thus, the proposed method provides a significant reduction in memory requirements on fixed-memory hardware (e.g., FPGAs) compared to the conventional method. As a result, the proposed method is highly efficient, scalable, and easily implementable in fixed memory hardware (e.g., FPGAs) to provide several orders of reduction in memory usage.

TABLE 2
Memory Usage of Conventional Method vs. Proposed Method

| | Memory Footprint (Units of Size N) | | Memory Usage (%) of |
|---|---|---|---|
| # of Layers | Conventional Method | Proposed | Proposed Method vs. |
| (k) | (2^{k} − 1) − (2^{k-2} − 1) | Method | Conventional Method |
| 2 | 3 | 1 | 33.3333 |
| 3 | 6 | 1 | 16.6667 |
| 4 | 12 | 1 | 8.3333 |
| 5 | 24 | 1 | 4.1667 |
| 6 | 48 | 1 | 2.0833 |
| 7 | 96 | 1 | 1.0417 |
| 8 | 192 | 1 | 0.5208 |
| 9 | 384 | 1 | 0.2604 |
| 10 | 768 | 1 | 0.1302 |
| 11 | 1536 | 1 | 0.0651 |
| 12 | 3072 | 1 | 0.0326 |
| 13 | 6144 | 1 | 0.0163 |
| 14 | 12288 | 1 | 0.0081 |
| 15 | 24576 | 1 | 0.0041 |
| 16 | 49152 | 1 | 0.0020 |
| 17 | 98304 | 1 | 0.0010 |
| 18 | 196608 | 1 | 0.0005 |
| 19 | 393216 | 1 | 0.0003 |
| 20 | 786432 | 1 | 0.0001 |

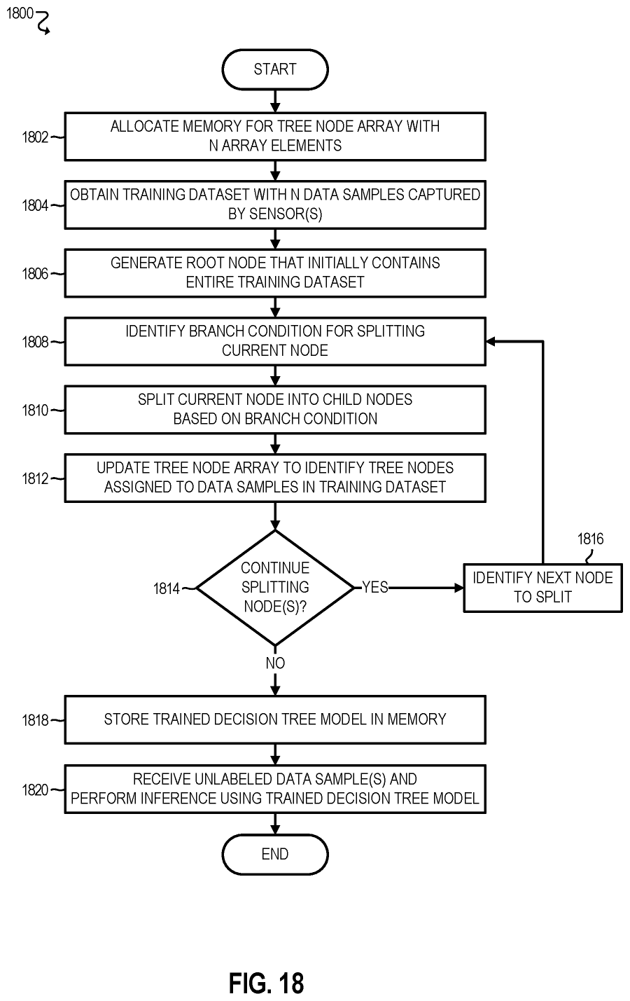

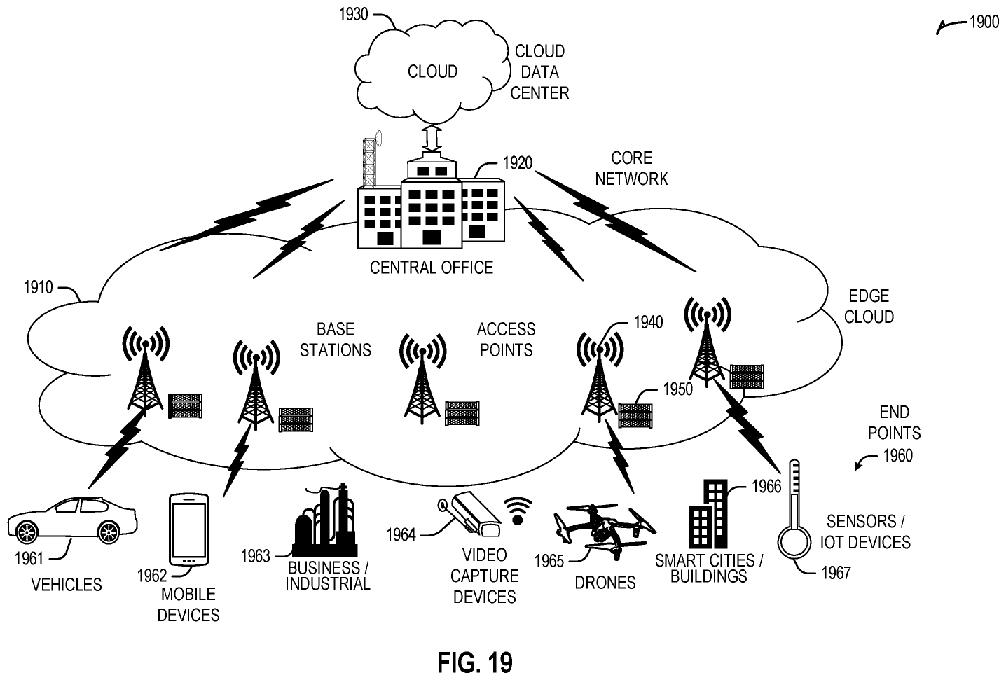

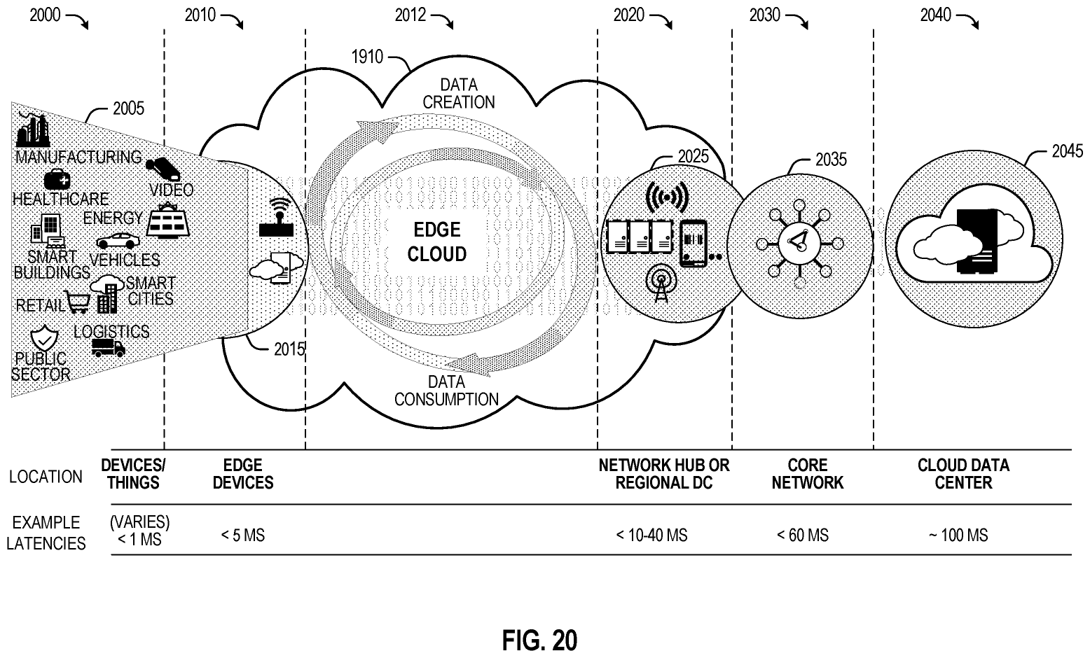

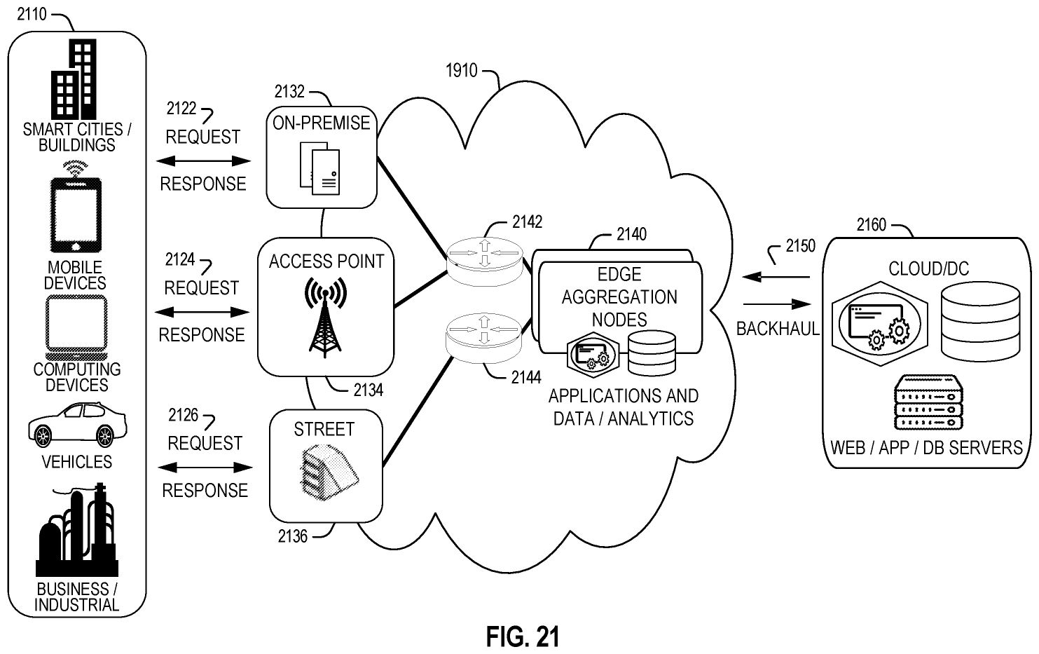

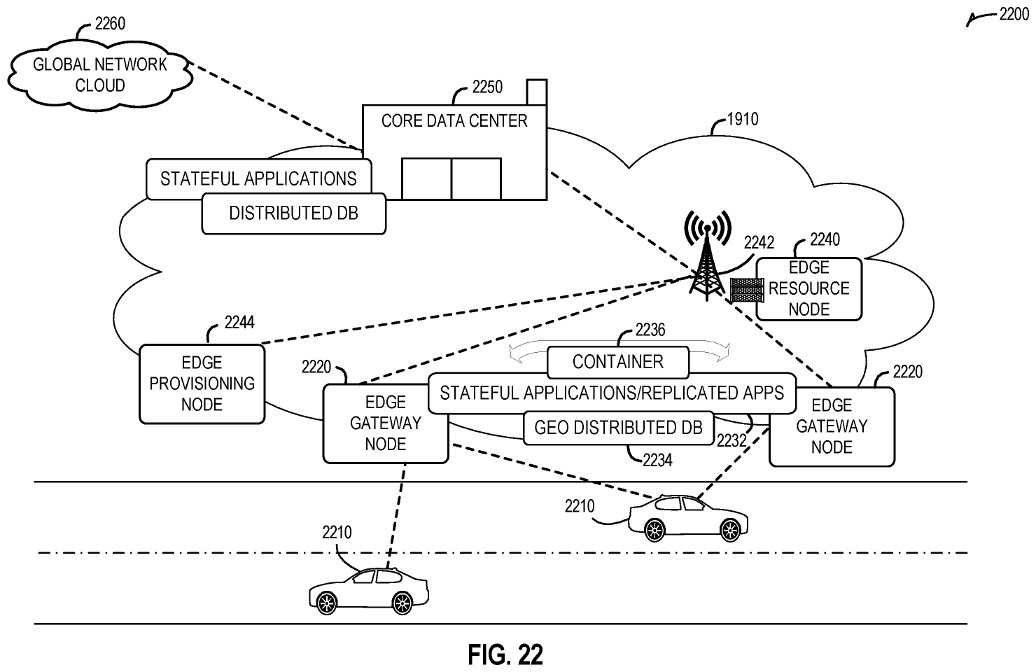

FIG. 18 illustrates a flowchart 1800 for a memory-efficient implementation of decision tree machine learning in accordance with certain embodiments. In some embodiments, for example, flowchart 1800 may be implemented and/or performed by or using the computing devices, systems, and/or platforms described throughout this disclosure, such as edge computing device 700 of FIG. 7; FPGA AI accelerator 1100 of FIG. 11; edge cloud resources 1910, cloud data center 1930, and/or endpoints 1960 of FIG. 19; endpoint devices/things 2000, edge devices 2010, network access layer resources 2020 (e.g., base stations, network hubs, regional data centers), core network resources 2030, and/or cloud data center 2040 of FIG. 20; endpoint devices 2110, on-premise resources 2132, access points 2134, street network resources 2136, edge aggregation nodes 2140, aggregation points 2142-2144, and/or cloud data center 2160 of FIG. 21; edge gateway node 2220 and/or edge resource node 2240 of FIG. 22; compute node 2300 of FIG. 23A; and/or computing node 2350 of FIG. 23B, among other examples.

In the illustrated example, flowchart 1800 is performed to train a decision tree model and/or perform inference using the trained model in a memory-efficient manner. For example, in some embodiments, flowchart 1800 may be performed on a resource-constrained device, such as an edge computing device, processing device, and/or an FPGA accelerator with limited resources (e.g., memory and processing circuitry).

The flowchart begins at block 1802, where memory is allocated for a tree node array that will be used to train the decision tree model. In some embodiments, for example, the tree node array may be allocated in fixed or static memory, which may be statically allocated before or at the beginning of program execution (e.g., fixed memory on an FPGA accelerator of an edge computing device). Moreover, the tree node array may be allocated with a particular number of array elements (N), which may be equal to the number of data samples in a training dataset that will be used to train the decision tree model.

For example, as discussed further below, each array element in the tree node array may be used to identify the tree node assigned to one of the data samples in the training dataset throughout the training process.

In other embodiments, however, the tree node array may be dynamically allocated in dynamic memory, such as dynamic random access memory (DRAM).

The flowchart then proceeds to block 1804 to obtain the training dataset that will be used to train the decision tree model. For example, the training dataset may include a collection of N data samples. Moreover, in some embodiments, the data samples may be captured and/or derived, at least partially, using one or more sensor(s). In various embodiments, the sensor(s) may be part of the processing/computing device used to implement flowchart 1800, or the sensors may be separate from that device and the sensor data may be obtained over a communication interface and/or network.

In some embodiments, each data sample in the training dataset may include a set of feature values for a feature set that will be used to train the decision tree model, along with a label identifying the “ground truth” value assigned to the data sample for a particular target variable. The target variable may represent whatever type of information the decision tree model will be trained to predict (e.g., a class label for classification, a numerical value or range for regression, and so forth).

For example, for a fault detection use case, the decision tree model may be trained to detect faults or failures in one or more devices (e.g., edge devices at the network edge), which can include any mechanical, electrical, and/or computer-related component, device, equipment, and/or infrastructure (e.g., vehicles, medical equipment, manufacturing equipment, power infrastructure, telecommunication or network infrastructure, edge servers and computing devices, and components thereof). Moreover, the feature set for a fault detection use case may include various characteristics or “features” associated with the operating environment of the particular device being monitored, some or all of which may be captured by sensors associated with the device. Further, the target variable may be an indication of whether a fault has or will occur in the device. In this manner, for a labeled data sample in the training dataset, the label may indicate whether a fault did actually occur in a device associated with the data sample. For an unlabeled data sample, however, the trained model will be used to predict whether a fault has or will occur based on the feature values in the unlabeled data sample.

The flowchart then cycles through blocks 1806-1816 to train the decision tree model based on the training dataset. For example, a root node of the decision tree model may be generated, which initially contains or is assigned to all data samples in the training dataset. Moreover, beginning with the root node, each node is recursively split into multiple child nodes based on an identified branch condition, where each child node is assigned to a corresponding subset of the data samples assigned to its parent node. The nodes continue to be split in this manner until each leaf node of the tree is assigned to a subset of data samples that all have the same label (e.g., data samples that belong to the same class).

Moreover, in some embodiments, the branch condition for splitting each node can be identified by analyzing the data samples assigned to the particular node. For example, an impurity metric, such as a Gini index, may be computed and evaluated for multiple possible cutoff points and subsets of data samples, and the optimal cutoff point may then be chosen based on the computed Gini indexes, which can then be used as the branch condition for that node.

For example, the branch condition may specify any type of condition or criteria defined based on a particular feature in the feature set, such as a threshold or cutoff value for that feature. In this manner, a node may be split into multiple child nodes by partitioning its assigned data samples into multiple subsets based on whether the respective feature values of the data samples satisfy the branch condition. The resulting subsets of data samples are then respectively assigned to the newly created child nodes of the split node.

Moreover, in some embodiments, the tree node array is continuously updated and/or overwritten to identify the tree nodes that are currently assigned to the respective data samples throughout the training process. For example, each array element in the tree node array may be used to identify the current tree node assigned to one of the data samples in the training dataset. In this manner, whenever a new child node is created and assigned to certain data samples, the array elements of the tree node array that correspond to the assigned data samples may be updated or overwritten with an identifier of the newly created node (e.g., a node number). In this manner, rather than using a separate array of size N to identify the data samples assigned to each node during training, a single tree node array of size N is used to identify the nodes currently assigned to the data samples throughout the training process, and its array elements are continuously updated and/or overwritten as new nodes and/or layers of the tree are created.

For example, at block 1806, a root node is generated for the decision tree model, which initially contains and is assigned to all data samples in the training dataset. At block 1808, a branch condition for splitting the root node is identified, and at block 1810, the root node is split into multiple child nodes—and multiple corresponding subsets of data samples—based on the identified branch condition (e.g., as described above). At block 1812, the tree node array is updated to identify the new child nodes assigned to the resulting subsets of data samples.

The flowchart then proceeds to block 1814 to determine whether to continue splitting additional node(s). For example, as explained above, the nodes may be recursively split until each leaf node is only assigned to data samples with the same label. Thus, if one or more of the leaf nodes are still assigned to data samples that have different labels, those node(s) need to be split again.

Accordingly, the flowchart proceeds to block 1816 to identify the next node to split, and then to blocks 1808-1812 to identify the branch conditions to split the node, split the node based on those branch conditions, and then update the tree node array to identify the new child nodes assigned to the resulting subsets of data samples. The flowchart repeats blocks 1808-1812 in this manner until it is determined at block 1814 that no additional nodes need to be split.

Upon determining that no additional nodes need to be split, the flowchart proceeds to block 1818 to store the trained decision tree model in memory. In some embodiments, for example, the trained decision tree model may include a representation of the tree nodes and their associated parent-child dependencies, the branch condition or rule identified for each node, and/or the label or class corresponding to each leaf node. In this manner, the trained model can subsequently be used to perform inference on an unlabeled data sample as described below.

For example, the flowchart then proceeds to block 1820 to receive unlabeled data sample(s) and perform inference on those data sample(s) using the trained decision tree model. In particular, similar to the labeled data samples, an unlabeled data sample may be captured, at least partially, based on one or more sensor(s). Moreover, the unlabeled data sample may contain feature values for the same feature set as the labeled data samples. Unlike the labeled data samples, however, a label has not yet been assigned to the unlabeled data sample, so the value of the target variable for the unlabeled sample is unknown and will be predicted using the trained model.

For example, the trained model can be used to perform inference on an unlabeled data sample by evaluating the data sample against the branch conditions or rules in a path from the root node to a leaf node of the tree, and then ultimately predicting that the data sample has the same label or class as the leaf node.

At this point, the flowchart may be complete. In some embodiments, however, the flowchart may restart and/or certain blocks may be repeated. For example, in some embodiments, the flowchart may restart at block 1802 to update and/or retrain the decision tree model based on new training data samples, or to train additional decision trees for the decision tree model. In some embodiments, for example, the decision tree model may be a random forest model, which may be trained to predict the target variable for the unlabeled data samples using multiple decision trees generated from the training dataset. Thus, the flowchart may repeat blocks 1806-1816 to continue training additional decision trees in the random forest model.

Alternatively, or additionally, the flowchart may proceed back to block 1820 to continue receiving unlabeled data sample(s) and performing inference using the decision tree model.

### Example Computing Environments

The following sections present examples of various computing devices, platforms, systems, and architectures that may be used to implement the decision tree functionality described throughout this disclosure.

Edge Computing Architectures

FIG. 19 is a block diagram 1900 showing an overview of a configuration for edge computing, which includes a layer of processing referred to in many of the following examples as an “edge cloud”. As shown, the edge cloud 1910 is co-located at an edge location, such as an access point or base station 1940, a local processing hub 1950, or a central office 1920, and thus may include multiple entities, devices, and equipment instances. The edge cloud 1910 is located much closer to the endpoint (consumer and producer) data sources 1960 (e.g., autonomous vehicles 1961, user equipment 1962, business and industrial equipment 1963, video capture devices 1964, drones 1965, smart cities and building devices 1966, sensors and IoT devices 1967, etc.) than the cloud data center 1930. Compute, memory, and storage resources which are offered at the edges in the edge cloud 1910 are critical to providing ultra-low latency response times for services and functions used by the endpoint data sources 1960 as well as reduce network backhaul traffic from the edge cloud 1910 toward cloud data center 1930 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. 20 illustrates operational layers among endpoints, an edge cloud, and cloud computing environments. Specifically, FIG. 20 depicts examples of computational use cases 2005, utilizing the edge cloud 1910 among multiple illustrative layers of network computing. The layers begin at an endpoint (devices and things) layer 2000, which accesses the edge cloud 1910 to conduct data creation, analysis, and data consumption activities. The edge cloud 1910 may span multiple network layers, such as an edge devices layer 2010 having gateways, on-premise servers, or network equipment (nodes 2015) located in physically proximate edge systems; a network access layer 2020, encompassing base stations, radio processing units, network hubs, regional data centers (DC), or local network equipment (equipment 2025); and any equipment, devices, or nodes located therebetween (in layer 2012, not illustrated in detail). The network communications within the edge cloud 1910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 2000, under 5 ms at the edge devices layer 2010, to even between 10 to 40 ms when communicating with nodes at the network access layer 2020. Beyond the edge cloud 1910 are core network 2030 and cloud data center 2040 layers, each with increasing latency (e.g., between 50-60 ms at the core network layer 2030, to 100 or more ms at the cloud data center layer). As a result, operations at a core network data center 2035 or a cloud data center 2045, with latencies of at least 50 to 100 ms or more, will not be able to accomplish many time-critical functions of the use cases 2005. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 2035 or a cloud data center 2045, a central office or content data network may be considered as being located within a “near edge” layer (“near” to the cloud, having high latency values when communicating with the devices and endpoints of the use cases 2005), whereas an access point, base station, on-premise server, or network gateway may be considered as located within a “far edge” layer (“far” from the cloud, having low latency values when communicating with the devices and endpoints of the use cases 2005). It will be understood that other categorizations of a particular network layer as constituting a “close”, “local”, “near”, “middle”, or “far” edge may be based on latency, distance, number of network hops, or other measurable characteristics, as measured from a source in any of the network layers 2000-2040.

The various use cases 2005 may access resources under usage pressure from incoming streams, due to multiple services utilizing the edge cloud. To achieve results with low latency, the services executed within the edge cloud 1910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1910 may provide the ability to serve and respond to multiple applications of the use cases 2005 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1910 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1910 (network layers 2000-2040), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1910.

As such, the edge cloud 1910 is formed from network components and functional features operated by and within edge gateway nodes, edge aggregation nodes, or other edge compute nodes among network layers 2010-2030. The edge cloud 1910 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1910 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 1910 may be servers, multi-tenant servers, appliance computing devices, and/or any other type of computing devices. For example, the edge cloud 1910 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 23B. The edge cloud 1910 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

In FIG. 21, various client endpoints 2110 (in the form of mobile devices, computers, autonomous vehicles, business computing equipment, industrial processing equipment) exchange requests and responses that are specific to the type of endpoint network aggregation. For instance, client endpoints 2110 may obtain network access via a wired broadband network, by exchanging requests and responses 2122 through an on-premise network system 2132. Some client endpoints 2110, such as mobile computing devices, may obtain network access via a wireless broadband network, by exchanging requests and responses 2124 through an access point (e.g., cellular network tower) 2134. Some client endpoints 2110, such as autonomous vehicles may obtain network access for requests and responses 2126 via a wireless vehicular network through a street-located network system 2136. However, regardless of the type of network access, the TSP may deploy aggregation points 2142, 2144 within the edge cloud 1910 to aggregate traffic and requests. Thus, within the edge cloud 1910, the TSP may deploy various compute and storage resources, such as at edge aggregation nodes 2140, to provide requested content. The edge aggregation nodes 2140 and other systems of the edge cloud 1910 are connected to a cloud or data center 2160, which uses a backhaul network 2150 to fulfill higher-latency requests from a cloud/data center for websites, applications, database servers, etc. Additional or consolidated instances of the edge aggregation nodes 2140 and the aggregation points 2142, 2144, including those deployed on a single server framework, may also be present within the edge cloud 1910 or other areas of the TSP infrastructure.

It should be appreciated that the edge computing systems and arrangements discussed herein may be applicable in various solutions, services, and/or use cases involving mobility. As an example, FIG. 22 shows a simplified vehicle compute and communication use case involving mobile access to applications in an edge computing system 2200 that implements an edge cloud 1910. In this use case, respective client compute nodes 2210 may be embodied as in-vehicle compute systems (e.g., in-vehicle navigation and/or infotainment systems) located in corresponding vehicles which communicate with the edge gateway nodes 2220 during traversal of a roadway. For instance, the edge gateway nodes 2220 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 2210 and a particular edge gateway device 2220 may propagate so as to maintain a consistent connection and context for the client compute node 2210. Likewise, mobile edge nodes may aggregate at the high priority services or according to the throughput or latency resolution requirements for the underlying service(s) (e.g., in the case of drones). The respective edge gateway devices 2220 include an amount of processing and storage capabilities and, as such, some processing and/or storage of data for the client compute nodes 2210 may be performed on one or more of the edge gateway devices 2220.

The edge gateway devices 2220 may communicate with one or more edge resource nodes 2240, which are illustratively embodied as compute servers, appliances or components located at or in a communication base station 2242 (e.g., a base station of a cellular network). As discussed above, the respective edge resource nodes 2240 include an amount of processing and storage capabilities and, as such, some processing and/or storage of data for the client compute nodes 2210 may be performed on the edge resource node 2240. For example, the processing of data that is less urgent or important may be performed by the edge resource node 2240, while the processing of data that is of a higher urgency or importance may be performed by the edge gateway devices 2220 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 2240 also communicate with the core data center 2250, which may include compute servers, appliances, and/or other components located in a central location (e.g., a central office of a cellular communication network). The core data center 2250 may provide a gateway to the global network cloud 2260 (e.g., the Internet) for the edge cloud 1910 operations formed by the edge resource node(s) 2240 and the edge gateway devices 2220. Additionally, in some examples, the core data center 2250 may include an amount of processing and storage capabilities and, as such, some processing and/or storage of data for the client compute devices may be performed on the core data center 2250 (e.g., processing of low urgency or importance, or high complexity).

The edge gateway nodes 2220 or the edge resource nodes 2240 may offer the use of stateful applications 2232 and a geographic distributed database 2234. Although the applications 2232 and database 2234 are illustrated as being horizontally distributed at a layer of the edge cloud 1910, it will be understood that resources, services, or other components of the application may be vertically distributed throughout the edge cloud (including, part of the application executed at the client compute node 2210, other parts at the edge gateway nodes 2220 or the edge resource nodes 2240, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 2236 (or pod of containers) may be flexibly migrated from an edge node 2220 to other edge nodes (e.g., 2220, 640, etc.) such that the container with an application and workload does not need to be reconstituted, re-compiled, re-interpreted in order for migration to work. However, in such settings, there may be some remedial or “swizzling” translation operations applied. For example, the physical hardware at node 2240 may differ from edge gateway node 2220 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 22 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 2220, some others at the edge resource node 2240, and others in the core data center 2250 or global network cloud 2260.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 2200 can include or be in communication with an edge provisioning node 2244. The edge provisioning node 2244 can distribute software such as the example computer readable instructions 2382 of FIG. 23B, to various receiving parties for implementing any of the methods described herein. The example edge provisioning node 2244 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 2244. For example, the entity that owns and/or operates the edge provisioning node 2244 may be a developer, a seller, and/or a licensor (or a customer and/or consumer thereof) of software instructions such as the example computer readable instructions 2382 of FIG. 23B. The receiving parties may be consumers, service providers, users, retailers, OEMs, etc., who purchase and/or license the software instructions for use and/or re-sale and/or sub-licensing.

In an example, edge provisioning node 2244 includes one or more servers and one or more storage devices. The storage devices host computer readable instructions such as the example computer readable instructions 2382 of FIG. 23B, as described below. Similarly to edge gateway devices 2220 described above, the one or more servers of the edge provisioning node 2244 are in communication with a base station 2242 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 2382 from the edge provisioning node 2244. For example, the software instructions, which may correspond to the example computer readable instructions 2382 of FIG. 23B, may be downloaded to the example processor platform's, which is to execute the computer readable instructions 2382 to implement the methods described herein.

In some examples, the processor platform(s) that execute the computer readable instructions 2382 can be physically located in different geographic locations, legal jurisdictions, etc. In some examples, one or more servers of the edge provisioning node 2244 periodically offer, transmit, and/or force updates to the software instructions (e.g., the example computer readable instructions 2382 of FIG. 23B) to ensure improvements, patches, updates, etc. are distributed and applied to the software instructions implemented at the end user devices. In some examples, different components of the computer readable instructions 2382 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

Example Computing Devices, Systems, and Platforms

In further examples, any of the compute nodes or devices discussed with reference to the present edge computing systems and environment may be fulfilled based on the components depicted in FIGS. 23A and 23B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 23A, an edge compute node 2300 includes a compute engine (also referred to herein as “compute circuitry”) 2302, an input/output (I/O) subsystem 2308, data storage 2310, a communication circuitry subsystem 2312, and, optionally, one or more peripheral devices 2314. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 2300 may be embodied as any type of engine, device, or collection of devices capable of performing various compute functions. In some examples, the compute node 2300 may be embodied as a single device such as an integrated circuit, an embedded system, a field-programmable gate array (FPGA), a system-on-a-chip (SOC), or other integrated system or device. In the illustrative example, the compute node 2300 includes or is embodied as a processor 2304 and a memory 2306. The processor 2304 may be embodied as any type of processor capable of performing the functions described herein (e.g., executing an application). For example, the processor 2304 may be embodied as a multi-core processor(s), a microcontroller, a processing unit, a specialized or special purpose processing unit, or other processor or processing/controlling circuit.

In some examples, the processor 2304 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 2304 may work in coordination with each other to execute many types of operations and instructions within and on behalf of the compute node 2300.

The memory 2306 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 2306 may be integrated into the processor 2304. The memory 2306 may store various software and data used during operation such as one or more applications, data operated on by the application(s), libraries, and drivers.

The compute circuitry 2302 is communicatively coupled to other components of the compute node 2300 via the I/O subsystem 2308, which may be embodied as circuitry and/or components to facilitate input/output operations with the compute circuitry 2302 (e.g., with the processor 2304 and/or the main memory 2306) and other components of the compute circuitry 2302. For example, the I/O subsystem 2308 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2308 may form a portion of a system-on-a-chip (SoC) and be incorporated, along with one or more of the processor 2304, the memory 2306, and other components of the compute circuitry 2302, into the compute circuitry 2302.

The one or more illustrative data storage devices 2310 may be embodied as any type of devices configured for short-term or long-term storage of data such as, for example, memory devices and circuits, memory cards, hard disk drives, solid-state drives, or other data storage devices. Individual data storage devices 2310 may include a system partition that stores data and firmware code for the data storage device 2310. Individual data storage devices 2310 may also include one or more operating system partitions that store data files and executables for operating systems depending on, for example, the type of compute node 2300.

The communication circuitry 2312 may be embodied as any communication circuit, device, or collection thereof, capable of enabling communications over a network between the compute circuitry 2302 and another compute device (e.g., an edge gateway of an implementing edge computing system). The communication circuitry 2312 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 2312 includes a network interface controller (NIC) 2320, which may also be referred to as a host fabric interface (HFI). The NIC 2320 may be embodied as one or more add-in-boards, daughter cards, network interface cards, controller chips, chipsets, or other devices that may be used by the compute node 2300 to connect with another compute device (e.g., an edge gateway node). In some examples, the NIC 2320 may be embodied as part of a system-on-a-chip (SoC) that includes one or more processors, or included on a multichip package that also contains one or more processors. In some examples, the NIC 2320 may include a local processor (not shown) and/or a local memory (not shown) that are both local to the NIC 2320. In such examples, the local processor of the NIC 2320 may be capable of performing one or more of the functions of the compute circuitry 2302 described herein. Additionally, or alternatively, in such examples, the local memory of the NIC 2320 may be integrated into one or more components of the client compute node at the board level, socket level, chip level, and/or other levels.

Additionally, in some examples, a respective compute node 2300 may include one or more peripheral devices 2314. Such peripheral devices 2314 may include any type of peripheral device found in a compute device or server such as audio input devices, a display, other input/output devices, interface devices, and/or other peripheral devices, depending on the particular type of the compute node 2300. In further examples, the compute node 2300 may be embodied by a respective edge compute node (whether a client, gateway, or aggregation node) in an edge computing system or like forms of appliances, computers, subsystems, circuitry, or other components.

In a more detailed example, FIG. 23B illustrates a block diagram of an example of components that may be present in an edge computing node 2350 for implementing the techniques (e.g., operations, processes, methods, and methodologies) described herein. This edge computing node 2350 provides a closer view of the respective components of node 2300 when implemented as or as part of a computing device (e.g., as a mobile device, a base station, server, gateway, etc.). The edge computing node 2350 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 2350, or as components otherwise incorporated within a chassis of a larger system.

The edge computing device 2350 may include processing circuitry in the form of a processor 2352, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2352 may be a part of a system on a chip (SoC) in which the processor 2352 and other components are formed into a single integrated circuit, or a single package, such as the Edison™ or Galileo™ SoC boards from Intel Corporation, Santa Clara, Calif. As an example, the processor 2352 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 2352 and accompanying circuitry may be provided in a single socket form factor, multiple socket form factor, or a variety of other formats, including in limited hardware configurations or configurations that include fewer than all elements shown in FIG. 23B.

The processor 2352 may communicate with a system memory 2354 over an interconnect 2356 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2358 may also couple to the processor 2352 via the interconnect 2356. In an example, the storage 2358 may be implemented via a solid-state disk drive (SSDD). Other devices that may be used for the storage 2358 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 2358 may be on-die memory or registers associated with the processor 2352. However, in some examples, the storage 2358 may be implemented using a micro hard disk drive (HDD). Further, any number of new technologies may be used for the storage 2358 in addition to, or instead of, the technologies described, such resistance change memories, phase change memories, holographic memories, or chemical memories, among others.

The components may communicate over the interconnect 2356. The interconnect 2356 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2356 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 2356 may couple the processor 2352 to a transceiver 2366, for communications with the connected edge devices 2362. The transceiver 2366 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2362. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2366 (or multiple transceivers) may communicate using multiple standards or radios for communications at a different range. For example, the edge computing node 2350 may communicate with close devices, e.g., within about 10 meters, using a local transceiver based on Bluetooth Low Energy (BLE), or another low power radio, to save power. More distant connected edge devices 2362, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 2366 (e.g., a radio transceiver) may be included to communicate with devices or services in a cloud (e.g., an edge cloud 2395) via local or wide area network protocols. The wireless network transceiver 2366 may be a low-power wide-area (LPWA) transceiver that follows the IEEE 802.15.4, or IEEE 802.15.4g standards, among others. The edge computing node 2350 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2366, as described herein. For example, the transceiver 2366 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2366 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2368 may be included to provide a wired communication to nodes of the edge cloud 2395 or to other devices, such as the connected edge devices 2362 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 2368 may be included to enable connecting to a second network, for example, a first NIC 2368 providing communications to the cloud over Ethernet, and a second NIC 2368 providing communications to other devices over another type of network.

Given the variety of types of applicable communications from the device to another component or network, applicable communications circuitry used by the device may include or be embodied by any one or more of components 2364, 2366, 2368, or 2370. Accordingly, in various examples, applicable means for communicating (e.g., receiving, transmitting, etc.) may be embodied by such communications circuitry.

The edge computing node 2350 may include or be coupled to acceleration circuitry 2364, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 2356 may couple the processor 2352 to a sensor hub or external interface 2370 that is used to connect additional devices or subsystems. The devices may include sensors 2372, such as accelerometers, level sensors, flow sensors, optical light sensors, camera sensors, temperature sensors, global navigation system (e.g., GPS) sensors, pressure sensors, barometric pressure sensors, and the like. The hub or interface 2370 further may be used to connect the edge computing node 2350 to actuators 2374, such as power switches, valve actuators, an audible sound generator, a visual warning device, and the like.

In some optional examples, various input/output (I/O) devices may be present within or connected to, the edge computing node 2350. For example, a display or other output device 2384 may be included to show information, such as sensor readings or actuator position. An input device 2386, such as a touch screen or keypad may be included to accept input. An output device 2384 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 2350. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2376 may power the edge computing node 2350, although, in examples in which the edge computing node 2350 is mounted in a fixed location, it may have a power supply coupled to an electrical grid, or the battery may be used as a backup or for temporary capabilities. The battery 2376 may be a lithium ion battery, or a metal-air battery, such as a zinc-air battery, an aluminum-air battery, a lithium-air battery, and the like.

A battery monitor/charger 2378 may be included in the edge computing node 2350 to track the state of charge (SoCh) of the battery 2376, if included. The battery monitor/charger 2378 may be used to monitor other parameters of the battery 2376 to provide failure predictions, such as the state of health (SoH) and the state of function (SoF) of the battery 2376. The battery monitor/charger 2378 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2378 may communicate the information on the battery 2376 to the processor 2352 over the interconnect 2356. The battery monitor/charger 2378 may also include an analog-to-digital (ADC) converter that enables the processor 2352 to directly monitor the voltage of the battery 2376 or the current flow from the battery 2376. The battery parameters may be used to determine actions that the edge computing node 2350 may perform, such as transmission frequency, mesh network operation, sensing frequency, and the like.

A power block 2380, or other power supply coupled to a grid, may be coupled with the battery monitor/charger 2378 to charge the battery 2376. In some examples, the power block 2380 may be replaced with a wireless power receiver to obtain the power wirelessly, for example, through a loop antenna in the edge computing node 2350. A wireless battery charging circuit, such as an LTC4020 chip from Linear Technologies of Milpitas, Calif., among others, may be included in the battery monitor/charger 2378. The specific charging circuits may be selected based on the size of the battery 2376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2358 may include instructions 2382 in the form of software, firmware, or hardware commands to implement the techniques described herein. Although such instructions 2382 are shown as code blocks included in the memory 2354 and the storage 2358, it may be understood that any of the code blocks may be replaced with hardwired circuits, for example, built into an application specific integrated circuit (ASIC).

In an example, the instructions 2382 provided via the memory 2354, the storage 2358, or the processor 2352 may be embodied as a non-transitory, machine-readable medium 2360 including code to direct the processor 2352 to perform electronic operations in the edge computing node 2350. The processor 2352 may access the non-transitory, machine-readable medium 2360 over the interconnect 2356. For instance, the non-transitory, machine-readable medium 2360 may be embodied by devices described for the storage 2358 or may include specific storage units such as optical disks, flash drives, or any number of other hardware devices. The non-transitory, machine-readable medium 2360 may include instructions to direct the processor 2352 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 2382 on the processor 2352 (separately, or in combination with the instructions 2382 of the machine readable medium 2360) may configure execution or operation of a trusted execution environment (TEE) 2390. In an example, the TEE 2390 operates as a protected area accessible to the processor 2352 for secure execution of instructions and secure access to data. Various implementations of the TEE 2390, and an accompanying secure area in the processor 2352 or the memory 2354 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2350 through the TEE 2390 and the processor 2352.

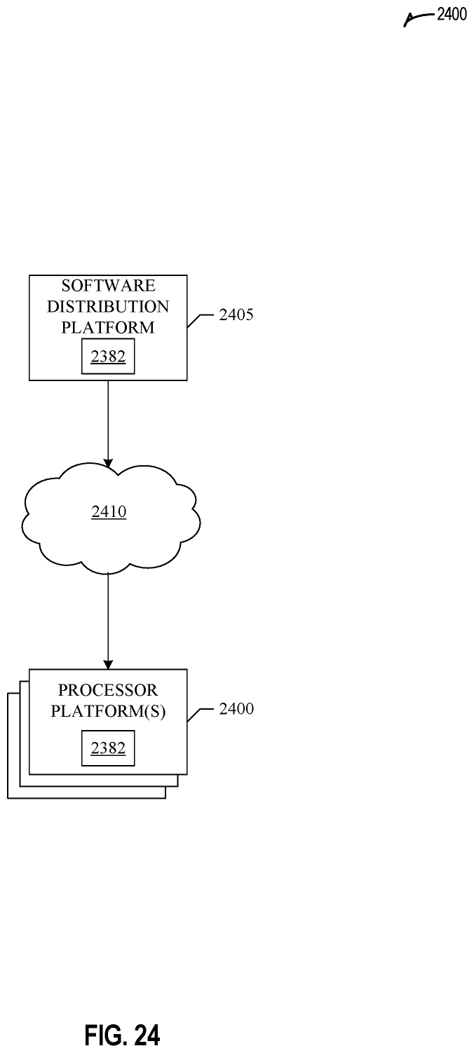

FIG. 24 illustrates an example software distribution platform 2405 to distribute software, such as the example computer readable instructions 2382 of FIG. 23B, to one or more devices, such as example processor platform(s) 2400 and/or example connected edge devices described throughout this disclosure. The example software distribution platform 2405 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 2405). Example connected edge devices may operate in commercial and/or home automation environments. In some examples, a third party is a developer, a seller, and/or a licensor of software such as the example computer readable instructions 2382 of FIG. 23B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 24, the software distribution platform 2405 includes one or more servers and one or more storage devices. The storage devices store the computer readable instructions 2382. The one or more servers of the example software distribution platform 2405 are in communication with a network 2410, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2382 from the software distribution platform 2405. For example, the software, which may correspond to the example computer readable instructions described throughout this disclosure, may be downloaded to the example processor platform(s) 2400 (e.g., example connected edge devices), which is/are to execute the computer readable instructions 2382 to implement the functionality described throughout this disclosure. In some examples, one or more servers of the software distribution platform 2405 are communicatively connected to one or more security domains and/or security devices through which requests and transmissions of the example computer readable instructions 2382 must pass. In some examples, one or more servers of the software distribution platform 2405 periodically offer, transmit, and/or force updates to the software (e.g., the example computer readable instructions 2382 of FIG. 23B) to ensure improvements, patches, updates, etc. are distributed and applied to the software at the end user devices.

In the illustrated example of FIG. 24, the computer readable instructions 2382 are stored on storage devices of the software distribution platform 2405 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 2382 stored in the software distribution platform 2405 are in a first format when transmitted to the example processor platform(s) 2400. In some examples, the first format is an executable binary in which particular types of the processor platform(s) 2400 can execute. However, in some examples, the first format is uncompiled code that requires one or more preparation tasks to transform the first format to a second format to enable execution on the example processor platform(s) 2400. For instance, the receiving processor platform(s) 2400 may need to compile the computer readable instructions 2382 in the first format to generate executable code in a second format that is capable of being executed on the processor platform(s) 2400. In still other examples, the first format is interpreted code that, upon reaching the processor platform(s) 2400, is interpreted by an interpreter to facilitate execution of instructions.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a processing device for training a decision tree model, comprising: a memory; and processing circuitry to: allocate, in the memory, a tree node array for training the decision tree model, wherein the tree node array comprises a plurality of array elements, wherein a number of array elements in the tree node array is equal to a number of data samples in a training dataset; obtain the training dataset for training the decision tree model, wherein the training dataset comprises a plurality of data samples captured at least partially by one or more sensors; train the decision tree model based on the training dataset, wherein: a root node of the decision tree model is initially assigned to the data samples in the training dataset; the root node is recursively split into a plurality of child nodes based on a plurality of branch conditions identified for the training dataset, wherein each child node is assigned to a corresponding subset of the data samples in the training dataset; and the tree node array is continuously updated during training of the decision tree model to identify the child nodes assigned to the data samples in the training dataset, wherein each array element in the tree node array identifies a corresponding child node assigned to one of the data samples in the training dataset; and store the decision tree model in the memory.

Example 2 includes the processing device of Example 1, wherein: a plurality of labels are assigned to the data samples in the training dataset; and the decision tree model is trained to predict a target variable for unlabeled data samples based on the labels assigned to the data samples in the training dataset.

Example 3 includes the processing device of Example 2, wherein the processing circuitry is further to: receive an unlabeled data sample, wherein the unlabeled data sample is captured at least partially by the one or more sensors; and perform inference using the decision tree model to predict the target variable for the unlabeled data sample.

Example 4 includes the processing device of Example 2, wherein: the decision tree model is trained to predict failures for one or more edge devices; and the target variable is to indicate whether a failure is predicted for the one or more edge devices.

Example 5 includes the processing device of Example 2, wherein the decision tree model comprises a random forest model, wherein the random forest model is trained to predict the target variable for the unlabeled data samples based on a plurality of decision trees generated from the training dataset.

Example 6 includes the processing device of Example 2, wherein the child nodes are recursively split into a plurality of leaf nodes until each leaf node is assigned to a corresponding subset of the data samples from the training dataset that are assigned with a same label.

Example 7 includes the processing device of Example 1, wherein the plurality of branch conditions are identified based on a plurality of Gini indexes computed for a plurality of subsets of the training dataset.

Example 8 includes the processing device of Example 1, wherein each array element in the tree node array comprises a node number of the corresponding child node assigned to one of the data samples in the training dataset.

Example 9 includes the processing device of Example 1, wherein: the processing device is a field-programmable gate array (FPGA), wherein the FPGA comprises the memory and the processing circuitry; and the memory comprises a fixed memory, wherein the fixed memory is to be statically allocated.

Example 10 includes the processing device of Example 1, wherein: the processing device is an edge computing device, wherein the edge computing device comprises the memory and the processing circuitry; and the memory comprises a dynamic memory, wherein the dynamic memory is to be dynamically allocated.

Example 11 includes the processing device of Example 1, wherein the processing circuitry to obtain the training dataset for training the decision tree model is further to: receive, via a host interface, the training dataset from a host processor; receive, via a network interface, the training dataset over a network; or retrieve the training dataset from the memory.

Example 12 includes at least one non-transitory machine-readable storage medium having instructions stored thereon, wherein the instructions, when executed on processing circuitry, cause the processing circuitry to: allocate, in a memory, a tree node array for training a decision tree model, wherein the tree node array comprises a plurality of array elements, wherein a number of array elements in the tree node array is equal to a number of data samples in a training dataset; obtain the training dataset for training the decision tree model, wherein the training dataset comprises a plurality of data samples captured at least partially by one or more sensors; train the decision tree model based on the training dataset, wherein: a root node of the decision tree model is initially assigned to the data samples in the training dataset; the root node is recursively split into a plurality of child nodes based on a plurality of branch conditions identified for the training dataset, wherein each child node is assigned to a corresponding subset of the data samples in the training dataset; and the tree node array is continuously updated during training of the decision tree model to identify the child nodes assigned to the data samples in the training dataset, wherein each array element in the tree node array identifies a corresponding child node assigned to one of the data samples in the training dataset; and store the decision tree model in the memory.

Example 13 includes the storage medium of Example 12, wherein: a plurality of labels are assigned to the data samples in the training dataset; and the decision tree model is trained to predict a target variable for unlabeled data samples based on the labels assigned to the data samples in the training dataset.

Example 14 includes the storage medium of Example 13, wherein the instructions further cause the processing circuitry to: receive an unlabeled data sample, wherein the unlabeled data sample is captured at least partially by the one or more sensors; and perform inference using the decision tree model to predict the target variable for the unlabeled data sample.

Example 15 includes the storage medium of Example 13, wherein: the decision tree model is trained to predict failures for one or more edge devices; and the target variable is to indicate whether a failure is predicted for the one or more edge devices.

Example 16 includes the storage medium of Example 13, wherein the decision tree model comprises a random forest model, wherein the random forest model is trained to predict the target variable for the unlabeled data samples based on a plurality of decision trees generated from the training dataset.

Example 17 includes the storage medium of Example 13, wherein the child nodes are recursively split into a plurality of leaf nodes until each leaf node is assigned to a corresponding subset of the data samples from the training dataset that are assigned with a same label.

Example 18 includes the storage medium of Example 12, wherein the plurality of branch conditions are identified based on a plurality of Gini indexes computed for a plurality of subsets of the training dataset.

Example 19 includes the storage medium of Example 12, wherein each array element in the tree node array comprises a node number of the corresponding child node assigned to one of the data samples in the training dataset.

Example 20 includes a computing device for training a decision tree model, comprising: a memory; interface circuitry; and processing circuitry to: allocate, in the memory, a tree node array for training the decision tree model, wherein the tree node array comprises a plurality of array elements, wherein a number of array elements in the tree node array is equal to a number of data samples in a training dataset; receive, via the interface circuitry, the training dataset for training the decision tree model, wherein the training dataset comprises a plurality of data samples captured at least partially by one or more sensors; train the decision tree model based on the training dataset, wherein: a root node of the decision tree model is initially assigned to the data samples in the training dataset; the root node is recursively split into a plurality of child nodes based on a plurality of branch conditions identified for the training dataset, wherein each child node is assigned to a corresponding subset of the data samples in the training dataset; and the tree node array is continuously updated during training of the decision tree model to identify the child nodes assigned to the data samples in the training dataset, wherein each array element in the tree node array identifies a corresponding child node assigned to one of the data samples in the training dataset; and store the decision tree model in the memory.

Example 21 includes the computing device of Example 20, wherein: a plurality of labels are assigned to the data samples in the training dataset; and the decision tree model is trained to predict a target variable for unlabeled data samples based on the labels assigned to the data samples in the training dataset.

Example 22 includes the computing device of Example 21, wherein the processing circuitry is further to: receive an unlabeled data sample, wherein the unlabeled data sample is captured at least partially by the one or more sensors; and perform inference using the decision tree model to predict the target variable for the unlabeled data sample.

Example 23 includes a method of training a decision tree model, comprising: allocating, in a memory, a tree node array for training the decision tree model, wherein the tree node array comprises a plurality of array elements, wherein a number of array elements in the tree node array is equal to a number of data samples in a training dataset; receiving, via interface circuitry, the training dataset for training the decision tree model, wherein the training dataset comprises a plurality of data samples captured at least partially by one or more sensors; training the decision tree model based on the training dataset, wherein: a root node of the decision tree model is initially assigned to the data samples in the training dataset; the root node is recursively split into a plurality of child nodes based on a plurality of branch conditions identified for the training dataset, wherein each child node is assigned to a corresponding subset of the data samples in the training dataset; and the tree node array is continuously updated during training of the decision tree model to identify the child nodes assigned to the data samples in the training dataset, wherein each array element in the tree node array identifies a corresponding child node assigned to one of the data samples in the training dataset; and storing the decision tree model in the memory.

Example 24 includes the method of Example 23, wherein: a plurality of labels are assigned to the data samples in the training dataset; and the decision tree model is trained to predict a target variable for unlabeled data samples based on the labels assigned to the data samples in the training dataset.

Example 25 includes the method of Example 24, further comprising: receiving, via the interface circuitry, an unlabeled data sample, wherein the unlabeled data sample is captured at least partially by the one or more sensors; and performing inference using the decision tree model to predict the target variable for the unlabeled data sample.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A processing device for training a decision tree model, comprising:
a memory; and
processing circuitry to:
allocate, in the memory, a tree node array for training the decision tree model, wherein the tree node array comprises a plurality of array elements, wherein a number of array elements in the tree node array is equal to a number of data samples in a training dataset;
obtain the training dataset for training the decision tree model, wherein the training dataset comprises a plurality of data samples captured at least partially by one or more sensors;
train the decision tree model based on the training dataset, wherein:
a root node of the decision tree model is initially assigned to the data samples in the training dataset;
the root node is recursively split into a plurality of child nodes based on a plurality of branch conditions identified for the training dataset, wherein each child node is assigned to a corresponding subset of the data samples in the training dataset; and
the tree node array is continuously updated during training of the decision tree model to identify the child nodes assigned to the data samples in the training dataset, wherein each array element in the tree node array identifies a corresponding child node assigned to one of the data samples in the training dataset; and
store the decision tree model in the memory.

2. The processing device of claim 1, wherein:
a plurality of labels are assigned to the data samples in the training dataset; and
the decision tree model is trained to predict a target variable for unlabeled data samples based on the labels assigned to the data samples in the training dataset.

3. The processing device of claim 2, wherein the processing circuitry is further to:
receive an unlabeled data sample, wherein the unlabeled data sample is captured at least partially by the one or more sensors; and
perform inference using the decision tree model to predict the target variable for the unlabeled data sample.

4. The processing device of claim 2, wherein:
the decision tree model is trained to predict failures for one or more edge devices; and
the target variable is to indicate whether a failure is predicted for the one or more edge devices.

5. The processing device of claim 2, wherein the decision tree model comprises a random forest model, wherein the random forest model is trained to predict the target variable for the unlabeled data samples based on a plurality of decision trees generated from the training dataset.

6. The processing device of claim 2, wherein the child nodes are recursively split into a plurality of leaf nodes until each leaf node is assigned to a corresponding subset of the data samples from the training dataset that are assigned with a same label.

7. The processing device of claim 1, wherein the plurality of branch conditions are identified based on a plurality of Gini indexes computed for a plurality of subsets of the training dataset.

8. The processing device of claim 1, wherein each array element in the tree node array comprises a node number of the corresponding child node assigned to one of the data samples in the training dataset.

9. The processing device of claim 1, wherein:
the processing device is a field-programmable gate array (FPGA), wherein the FPGA comprises the memory and the processing circuitry; and
the memory comprises a fixed memory, wherein the fixed memory is to be statically allocated.

10. The processing device of claim 1, wherein:
the processing device is an edge computing device, wherein the edge computing device comprises the memory and the processing circuitry; and
the memory comprises a dynamic memory, wherein the dynamic memory is to be dynamically allocated.

11. The processing device of claim 1, wherein the processing circuitry to obtain the training dataset for training the decision tree model is further to:
receive, via a host interface, the training dataset from a host processor;
receive, via a network interface, the training dataset over a network; or
retrieve the training dataset from the memory.

12. At least one non-transitory machine-readable storage medium having instructions stored thereon, wherein the instructions, when executed on processing circuitry, cause the processing circuitry to:
allocate, in a memory, a tree node array for training a decision tree model, wherein the tree node array comprises a plurality of array elements, wherein a number of array elements in the tree node array is equal to a number of data samples in a training dataset;
obtain the training dataset for training the decision tree model, wherein the training dataset comprises a plurality of data samples captured at least partially by one or more sensors;
train the decision tree model based on the training dataset, wherein:
a root node of the decision tree model is initially assigned to the data samples in the training dataset;
the root node is recursively split into a plurality of child nodes based on a plurality of branch conditions identified for the training dataset, wherein each child node is assigned to a corresponding subset of the data samples in the training dataset; and
the tree node array is continuously updated during training of the decision tree model to identify the child nodes assigned to the data samples in the training dataset, wherein each array element in the tree node array identifies a corresponding child node assigned to one of the data samples in the training dataset; and
store the decision tree model in the memory.

13. The storage medium of claim 12, wherein:
a plurality of labels are assigned to the data samples in the training dataset; and
the decision tree model is trained to predict a target variable for unlabeled data samples based on the labels assigned to the data samples in the training dataset.

14. The storage medium of claim 13, wherein the instructions further cause the processing circuitry to:
receive an unlabeled data sample, wherein the unlabeled data sample is captured at least partially by the one or more sensors; and
perform inference using the decision tree model to predict the target variable for the unlabeled data sample.

15. The storage medium of claim 13, wherein:
the decision tree model is trained to predict failures for one or more edge devices; and
the target variable is to indicate whether a failure is predicted for the one or more edge devices.

16. The storage medium of claim 13, wherein the decision tree model comprises a random forest model, wherein the random forest model is trained to predict the target variable for the unlabeled data samples based on a plurality of decision trees generated from the training dataset.

17. The storage medium of claim 13, wherein the child nodes are recursively split into a plurality of leaf nodes until each leaf node is assigned to a corresponding subset of the data samples from the training dataset that are assigned with a same label.

18. The storage medium of claim 12, wherein the plurality of branch conditions are identified based on a plurality of Gini indexes computed for a plurality of subsets of the training dataset.

19. The storage medium of claim 12, wherein each array element in the tree node array comprises a node number of the corresponding child node assigned to one of the data samples in the training dataset.

20. A computing device for training a decision tree model, comprising:
a memory;
interface circuitry; and
processing circuitry to:
allocate, in the memory, a tree node array for training the decision tree model, wherein the tree node array comprises a plurality of array elements, wherein a number of array elements in the tree node array is equal to a number of data samples in a training dataset;
receive, via the interface circuitry, the training dataset for training the decision tree model, wherein the training dataset comprises a plurality of data samples captured at least partially by one or more sensors;
train the decision tree model based on the training dataset, wherein:
a root node of the decision tree model is initially assigned to the data samples in the training dataset;
the root node is recursively split into a plurality of child nodes based on a plurality of branch conditions identified for the training dataset, wherein each child node is assigned to a corresponding subset of the data samples in the training dataset; and
the tree node array is continuously updated during training of the decision tree model to identify the child nodes assigned to the data samples in the training dataset, wherein each array element in the tree node array identifies a corresponding child node assigned to one of the data samples in the training dataset; and
store the decision tree model in the memory.

21. The computing device of claim 20, wherein:
a plurality of labels are assigned to the data samples in the training dataset; and
the decision tree model is trained to predict a target variable for unlabeled data samples based on the labels assigned to the data samples in the training dataset.

22. The computing device of claim 21, wherein the processing circuitry is further to:
receive an unlabeled data sample, wherein the unlabeled data sample is captured at least partially by the one or more sensors; and
perform inference using the decision tree model to predict the target variable for the unlabeled data sample.

23. A method of training a decision tree model, comprising:
allocating, in a memory, a tree node array for training the decision tree model, wherein the tree node array comprises a plurality of array elements, wherein a number of array elements in the tree node array is equal to a number of data samples in a training dataset;
receiving, via interface circuitry, the training dataset for training the decision tree model, wherein the training dataset comprises a plurality of data samples captured at least partially by one or more sensors;
training the decision tree model based on the training dataset, wherein:
a root node of the decision tree model is initially assigned to the data samples in the training dataset;
the root node is recursively split into a plurality of child nodes based on a plurality of branch conditions identified for the training dataset, wherein each child node is assigned to a corresponding subset of the data samples in the training dataset; and
the tree node array is continuously updated during training of the decision tree model to identify the child nodes assigned to the data samples in the training dataset, wherein each array element in the tree node array identifies a corresponding child node assigned to one of the data samples in the training dataset; and
storing the decision tree model in the memory.

24. The method of claim 23, wherein:
a plurality of labels are assigned to the data samples in the training dataset; and
the decision tree model is trained to predict a target variable for unlabeled data samples based on the labels assigned to the data samples in the training dataset.

25. The method of claim 24, further comprising:
receiving, via the interface circuitry, an unlabeled data sample, wherein the unlabeled data sample is captured at least partially by the one or more sensors; and
performing inference using the decision tree model to predict the target variable for the unlabeled data sample.
